(19) United States
(12) Patent Application Publication
(10) Pub. No.: US 2026/0250126 A1
(43) Pub. Date: Aug. 27, 2026

(54) METHODS OF USING AND PREPARING METAL SULFIDE CATALYST

(71) Applicants: Saudi Arabian Oil Company, Dhahran (SA); King Abdullah University of Science and Technology, Thuwal (SA)

(72) Inventors: Pedro Castano, Thuwal (SA); Hend Mohamed, Thuwal (SA); Hassan A. Aljama, Al Qatif (SA); Zainab Alaithan, Dammam (SA)

(21) Appl. No.: 19/007,968

(22) Filed: Jan. 2, 2025

(51) Int. Cl. C01B 3/04; B01J 21/04; B01J 27/051; B01J 35/52; B01J 35/61; B01J 37/34; B01J 38/48

(52) U.S. Cl. CPC C01B 3/04; B01J 21/04; B01J 27/051; B01J 35/52; B01J 35/613; B01J 37/343; B01J 38/48; C01B 2203/0277; C01B 2203/1041; C01B 2203/1082; C01B 2203/1205

(57) ABSTRACT

A method for converting hydrogen sulfide (H₂S) to hydrogen (H₂) and sulfur(S) includes contact a H₂S-containing feed gas stream with a molybdenum disulfide (MoS₂) catalyst at a temperature of about 500 to about 1000° C., thereby converting at least a portion of the H₂S to H₂ and S and producing a spent catalyst in-situ and a residue gas stream leaving the reactor. A method for preparing the MoS₂ catalyst in the form of a flower-like nanosheet microsphere. A method for preparing the MoS₂ catalyst in the form of a nanosheet.

### TECHNICAL FIELD

The present disclosure relates to a hydrogen sulfide splitting method, more particularly, to a method for converting hydrogen sulfide to hydrogen and sulfur using a molybdenum disulfide (MoS₂) catalyst. The present disclosure also provides a method for preparing the MoS₂ catalyst, more particularly, to a method for preparing a flower-like MoS₂ nanosheet microsphere.

### BACKGROUND

Throughout the drilling and production of crude oil, hydrogen sulfide (H₂S) is released as a gas from various processes. The presence of H₂S in crude oil production not only poses significant health risks but also introduces corrosion concerns and the potential for reactions with other hydrocarbons. This compound, known for its toxic nature, can have detrimental effects on both human health and the integrity of equipment and infrastructure.

The production of hydrogen (H₂) from H₂S presents an opportunity to convert an environmentally toxic and hazardous material into a valuable product. Currently, H₂S is treated in oil and gas processing facilities using sulfur recovery units (SRU), such as the Claus process. Recovering H₂ from H₂S offers sustainability improvements, considering the importance of H₂ and its low carbon footprint. Processes, including partial oxidation, reformation, thermochemical, thermo-catalytical, and photocatalytic decomposition, have been explored in the field of H₂S conversion. However, these processes still suffer from limited H₂ yield and complex process requirements. Accordingly, there is a need to develop an efficient H₂S splitting process to overcome the above-mentioned challenges.

### SUMMARY

In one exemplary embodiment, a method for converting hydrogen sulfide (H₂S) to hydrogen (H₂) and sulfur(S) includes introducing a H₂S-containing feed gas stream into a reactor comprising a molybdenum disulfide (MoS₂) catalyst; passing the H₂S-containing feed gas stream through the reactor to contact the H₂S-containing feed gas stream with the MoS₂ catalyst at a temperature of about 500 to about 1000° C., thereby converting at least a portion of the H₂S to H₂ and S and producing a spent catalyst in-situ and a residue gas stream leaving the reactor; and separating the H₂ from the residue gas stream to generate a H₂-containing product gas stream. In some embodiments, the MoS₂ catalyst is in the form of a flower-like nanosheet microsphere or a nanosheet. In some embodiments, the S is deposited on surfaces and pores of the MoS₂ catalyst in the formation of the spent catalyst.

In some embodiments, the H₂S is present in the H₂S-containing feed gas stream at a concentration of about 0.5 to about 90 volume percentage (vol. %) based on a total volume of the H₂S-containing feed gas stream.

In some embodiments, the H₂S-containing feed gas stream further includes an inert gas selected from the group consisting of nitrogen, argon, and helium.

In some embodiments, the reactor is selected from the group consisting of a fixed-bed reactor, a trickle-bed reactor, a moving bed reactor, a rotating bed reactor, a fluidized bed reactor, and a slurry reactor.

In some embodiments, the passing the H₂S-containing feed gas stream through the reactor is carried out at a spacetime of about 0.01 to about 10 grams seconds per milliliter (g s mL⁻¹) at a temperature of about 700° C.

In some embodiments, the conversion of H₂S to H₂ and S is about 7 to about 20% based on an initial concentration of the H₂S in the H₂S-containing feed gas stream at a temperature of about 700° C.

In some embodiments, the MoS₂ catalyst is in the form of a flower-like nanosheet microsphere.

In some embodiments, the flower-like nanosheet microsphere has an average particle size of about 400 to about 1000 nanometers (nm).

In some embodiments, each flower-like nanosheet microsphere contains a hollow spherical core and a plurality of interconnected nanosheets growing perpendicular to a surface of the hollow spherical core.

In some embodiments, the plurality of interconnected nanosheets have an average width of about 100 to about 300 nm and an average thickness of about 1 to about 15 nm.

In some embodiments, the flower-like nanosheet microsphere has a surface area in a range of about 20 to about 50 square meters per gram (m²/g).

In some embodiments, the MoS₂ catalyst is supported on a support material. In some embodiments, the support material is selected from the group consisting of a metal oxide, a carbon material, a silica material, and combinations thereof.

In some embodiments, the support material is alumina.

In some embodiments, the method further includes regenerating the MoS₂ catalyst by washing the spent catalyst with two or more solvents and drying.

In some embodiments, the method further includes preparing the MoS₂ catalyst by a hydrothermal method. In some embodiments, the hydrothermal method includes mixing a molybdenum salt and a reducing agent in water to form a first mixture; mixing a sulfur precursor in water to form a second mixture; mixing the first mixture with the second mixture to form a reaction mixture; heating the reaction mixture at a temperature of about 160 to about 220° C. to form a crude product in the form of a precipitate; and separating the crude product from the reaction mixture and drying.

In some embodiments, the molybdenum salt is selected from the group consisting of sodium molybdate (Na₂MoO₄), potassium molybdate (K₂MoO₄), calcium molybdate (CaMoO₄), barium molybdate (BaMoO₄), lithium molybdate (Li₂MoO₄), magnesium molybdate (MgMoO₄), zinc molybdate (ZnMoO₄), ammonium heptamolybdate ((NH4)₆Mo₇O₂₄), ammonium orthomolybdate ((NH4)₂MoO₄), hydrates thereof, and mixtures thereof.

In some embodiments, the reducing agent is selected from the group consisting of citric acid, oxalic acid, ascorbic acid, hydrates thereof, and mixtures thereof.

In some embodiments, the sulfur precursor is selected from the group consisting of thioacetamide (CH₃CSNH₂) and thiourea (CH₄N₂S), hydrates thereof, and mixtures thereof.

In some embodiments, the method further includes preparing the MoS₂ catalyst by an exfoliation method. In some embodiments, the exfoliation method includes dispersing a bulk MoS₂ material in a solvent to form a suspension and sonicating at a temperature of about 0 to about 50° C.; and separating the MoS₂ in the form of nanosheets from the suspension by centrifugation.

In some embodiments, the solvent is selected from the group consisting of an aromatic solvent, a ketone solvent, a glycol solvent, an ester solvent, an amine solvent, an amide solvent, an alcohol solvent, a polar protic solvent, a polar aprotic solvent, water, and mixtures thereof.

### BRIEF DESCRIPTION OF THE DRAWINGS

FIG. 1A shows X-ray diffraction (XRD) profiles of MoS₂ catalyst samples Cat₁ to Cat₄ prepared by a hydrothermal method, according to certain embodiments of the present disclosure.

FIG. 1B shows XRD profiles of MoS₂ catalyst samples Cat₈ to Cat₇ prepared by the hydrothermal method, according to certain embodiments of the present disclosure.

FIG. 1C shows XRD profiles of MoS₂ catalyst samples Cat₈ to Cat₁₀ prepared by the hydrothermal method, according to certain embodiments of the present disclosure.

FIG. 1D shows XRD profiles of MoS₂ catalyst samples Cat₁ to Cat₁₆ prepared by the hydrothermal method, according to certain embodiments of the present disclosure.

FIG. 2A is a plotted graph illustrating the N₂ adsorption/desorption isotherms of MoS₂ catalyst samples commercial (CM), Cat₁, Cat₅ to Cat₁₀ prepared by the hydrothermal method, according to certain embodiments of the present disclosure.

FIG. 2B is a plotted graph illustrating the pore diameter of MoS₂ catalyst samples CM, Cat₁, Cat₅ to Cat₁₀ prepared by the hydrothermal method, according to certain embodiments of the present disclosure.

FIG. 3A is a Field Emission Scanning Electron Microscopy (FESEM) image of the MoS₂ catalyst sample Cat₁ at a magnification of 100 μm, according to certain embodiments of the present disclosure.

FIG. 3B is an FESEM image of the MoS₂ catalyst sample Cat₁ at a magnification of 3 μm, according to certain embodiments of the present disclosure.

FIG. 3C is an FESEM image of the MoS₂ catalyst sample Cat₁ at a magnification of 1 μm, according to certain embodiments of the present disclosure.

FIG. 3D is an FESEM image of the MoS₂ catalyst sample Cat₁ at a magnification of 500 nm, according to certain embodiments of the present disclosure.

FIG. 4A is an FESEM image of the MoS₂ catalyst sample Cat₂ at a magnification of 30 μm, according to certain embodiments of the present disclosure.

FIG. 4B is an FESEM image of the MoS₂ catalyst sample Cat₂ at a magnification of 3 μm, according to certain embodiments of the present disclosure.

FIG. 4C is an FESEM image of the MoS₂ catalyst sample Cat₂ at a magnification of 1 μm, according to certain embodiments of the present disclosure.

FIG. 4D is an FESEM image of the MoS₂ catalyst sample Cat₂ at a magnification of 500 nm, according to certain embodiments of the present disclosure.

FIG. 5A is an FESEM image of the MoS₂ catalyst sample Cat₅ at a magnification of 30 μm, according to certain embodiments of the present disclosure.

FIG. 5B is an FESEM image of the MoS₂ catalyst sample Cat₅ at a magnification of 3 μm, according to certain embodiments of the present disclosure.

FIG. 5C is an FESEM image of the MoS₂ catalyst sample Cat₅ at a magnification of 1 μm, according to certain embodiments of the present disclosure.

FIG. 5D is an FESEM image of the MoS₂ catalyst sample Cat₅ at a magnification of 500 nm, according to certain embodiments of the present disclosure.

FIG. 6A is an FESEM image of the MoS₂ catalyst sample Cat₆ at a magnification of 20 μm, according to certain embodiments of the present disclosure.

FIG. 6B is an FESEM image of the MoS₂ catalyst sample Cat₆ at a magnification of 3 μm, according to certain embodiments of the present disclosure.

FIG. 6C is an FESEM image of the MoS₂ catalyst sample Cat₆ at a magnification of 1 μm, according to certain embodiments of the present disclosure.

FIG. 6D is an FESEM image of the MoS₂ catalyst sample Cat₆ at a magnification of 500 nm, according to certain embodiments of the present disclosure.

FIG. 7A is an FESEM image of the MoS₂ catalyst sample Cat₇ at a magnification of 10 μm, according to certain embodiments of the present disclosure.

FIG. 7B is an FESEM image of the MoS₂ catalyst sample Cat₇ at a magnification of 3 μm, according to certain embodiments of the present disclosure.

FIG. 7C is an FESEM image of the MoS₂ catalyst sample Cat₇ at a magnification of 1 μm, according to certain embodiments of the present disclosure.

FIG. 7D is an FESEM image of the MoS₂ catalyst sample Cat₇ at a magnification of 500 nm, according to certain embodiments of the present disclosure.

FIG. 8A is an FESEM image of the MoS₂ catalyst sample Cat₈ at a magnification of 5 μm, according to certain embodiments of the present disclosure.

FIG. 8B is an FESEM image of the MoS₂ catalyst sample Cat₈ at a magnification of 3 μm, according to certain embodiments of the present disclosure.

FIG. 8C is an FESEM image of the MoS₂ catalyst sample Cat₈ at a magnification of 1 μm, according to certain embodiments of the present disclosure.

FIG. 8D is an FESEM image of the MoS₂ catalyst sample Cat₈ at a magnification of 500 nm, according to certain embodiments of the present disclosure.

FIG. 9A is an FESEM image of the MoS₂ catalyst sample Cat₉ at a magnification of 5 μm, according to certain embodiments of the present disclosure.

FIG. 9B is an FESEM image of the MoS₂ catalyst sample Cat₆ at a magnification of 3 μm, according to certain embodiments of the present disclosure.

FIG. 9C is an FESEM image of the MoS₂ catalyst sample Cat₆ at a magnification of 1 μm, according to certain embodiments of the present disclosure.

FIG. 9D is an FESEM image of the MoS₂ catalyst sample Cat₆ at a magnification of 500 nm, according to certain embodiments of the present disclosure.

FIG. 10A is an FESEM image of the MoS₂ catalyst sample Cat₁₀ at a magnification of 5 μm, according to certain embodiments of the present disclosure.

FIG. 10B is an FESEM image of the MoS₂ catalyst sample Cat₁₀ at a magnification of 3 μm, according to certain embodiments of the present disclosure.

FIG. 10C is an FESEM image of the MoS₂ catalyst sample Cat₁₀ at a magnification of 1 μm, according to certain embodiments of the present disclosure.

FIG. 10D is an FESEM image of the MoS₂ catalyst sample Cat₁₀ at a magnification of 500 nm, according to certain embodiments of the present disclosure.

FIG. 11 is a plotted graph illustrating H₂S conversion of MoS₂ catalyst samples CM, Cat₁, Cat₂, Cat₁₀, and Cat₁₁ prepared by the hydrothermal method, according to certain embodiments of the present disclosure.

FIG. 12 is a plotted graph illustrating H₂S conversion of MoS₂ catalyst samples CM and Cat₃₁ prepared by an exfoliation method, according to certain embodiments of the present disclosure.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used herein, the terms “room temperature” and “ambient temperature” refer to a temperature in a range of 25 degrees Celsius (° C.)±3° C. in the present disclosure.

As used herein, the terms “particle size” and “pore size” are thought of as the lengths or longest dimensions of a particle and of a pore opening, respectively.

As used herein, the terms “sonication” and “sonicate” refer to the process in which sound waves are used to agitate particles in a solution.

As used herein, the term “de-ionized water” refers to the water that has (most of) the ions removed.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

As used herein, the terms “metal organic framework,” or “MOF,” refer to a coordination network with organic ligands containing potential voids. A coordination network is a coordination compound extending, through repeating coordination entities, in one dimension, but with cross-links between two or more individual chains, loops, or spiro-links, or a coordination compound extending through repeating coordination entities in two or three dimensions. A coordination entity is an ion or neutral molecule that is composed of a central atom, usually that of a metal, to which is attached a surrounding array of atoms or groups of atoms, each of which is called a ligand. More succinctly, a metal organic framework is characterized by metal ions or clusters coordinated to organic ligands to form one-, two-, or three-dimensional structures. A MOF exhibits a regular void or pore structure. The nature of the void or pore structure may be impacted by various properties or structural factors. These properties include the geometry of the metal ions or clusters, the arrangement of the linkages between metal ions or clusters, and the number, identity, and spatial arrangement of voids or pores. These properties may be described as the structure of the repeat units and the nature of the arrangement of the repeat units. The specific structure of the MOF, which may include the void or pore structure, is referred to as the MOF topology.

MOF-containing imidazole or benzimidazole ligands are referred to as zeolitic imidazolate frameworks (ZIFs). As used herein, the terms “zeolitic,” “zeolite,” or “zeolitic materials” refer to a material having the crystalline structure or three-dimensional framework of a zeolite. Zeolites are porous silicate or aluminosilicate minerals that occur in nature. Elementary building units of zeolites are SiO₄ (and if appropriate, AlO₄) tetrahedra. Adjacent tetrahedra are linked at their corners via a common oxygen atom, which results in an inorganic macromolecule with a three-dimensional framework (also referred to as the zeolite framework). The three-dimensional framework of a zeolite also comprises channels, channel intersections, and cages having dimensions in the range of about 0.1 to about 10 nm, such as about 0.2 to about 5 nm, or about 0.2 to about 2 nm. Water molecules may be present inside these channels, channel intersections, and/or cages. Zeolites which are devoid of aluminum may be referred to as “all-silica zeolites” or “aluminum-free zeolites”. Some zeolites which are substantially free of, but not devoid of, aluminum are referred to as “high-silica zeolites”.

As used herein, the term “uniform shape” refers to an average consistent shape, including but not limited to, a flower-like nanosheet microsphere or a nanosheet, that differs by no more than about 10%, such as by no more than about 5%, by no more than about 4%, by no more than about 3%, by no more than about 2%, or by no more than about 1% of the distribution of particles having a different shape.

As used herein, the term “non-uniform shape” refers to an average consistent shape that differs by more than about 10%, such as more than about 15%, more than about 20%, or more than about 30% of the distribution of particles having a different shape.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

In view of the forgoing, one objective of the present disclosure is to provide a method for converting hydrogen sulfide to hydrogen and sulfur using a molybdenum disulfide (MoS₂) catalyst. A second objective of the present disclosure is to provide methods for making the MoS₂ catalyst by a hydrothermal method. A third objective of the present disclosure is to provide methods for making the MoS₂ catalyst by an exfoliation method.

Provided in the present disclosure is a method for converting hydrogen sulfide (H₂S) to hydrogen (H₂) and sulfur(S). The method of the present disclosure is effective in recovering the high value product, H₂, from H₂S under mild conditions, achieving a high yield and production rate in the presence of a metal sulfide catalyst, such as a MoS₂ catalyst. Additionally, the present disclosure also includes a cost-effective method of preparing the MoS₂ catalyst through a relatively simple operation, resulting in enhanced surface areas and controlled morphologies, thereby making it suitable for large-scale production and manufacturing processes.

According to an aspect of the present disclosure, a method for converting H₂S to H₂ and S includes introducing a H₂S-containing feed gas stream into a reactor containing a molybdenum disulfide (MoS₂) catalyst. In some embodiments, the H₂S is present in the H₂S-containing feed gas stream at a concentration of about 0.1 to about 90 volume percentage (vol. %), such as about 0.5 to about 80 vol. %, about 1 to about 70 vol. %, about 2 to about 60 vol. %, about 3 to about 50 vol. %, about 4 to about 40 vol. %, about 5 to about 30 vol. %, about 6 to about 20 vol. %, or about 1 vol. %, about 2 vol. %, about 4 vol. %, about 8 vol. %, about 16 vol. %, about 32 vol. %, about 64 vol. %, or about 86 vol. % based on a total volume of the H₂S-containing feed gas stream. In further embodiments, the H₂S-containing feed gas stream includes H₂S at a concentration of about 20 vol. %, based on the total volume of the H₂S-containing feed gas stream. In further embodiments, the H₂S-containing feed gas stream includes H₂S at a concentration of about 40 vol. %, based on the total volume of the H₂S-containing feed gas stream. In further embodiments, the H₂S-containing feed gas stream includes H₂S at a concentration of about 60 vol. %, based on the total volume of the H₂S-containing feed gas stream.

In some embodiments, the H₂S-containing feed gas stream further includes an inert gas selected from the group consisting of nitrogen, argon, and helium. In some embodiments, the inert gas is nitrogen. The concentration of the inert gas present in the H₂S-containing feed gas stream is in a range of about 0 to about 20 vol. %, such as about 1 to about 17 vol. %, about 3 to about 14 vol. %, about 5 to about 11 vol. %, or about 8 vol. % based on the total volume of the H₂S-containing feed gas stream. In further embodiments, the concentration of the inert gas present in the H₂S-containing feed gas stream is about 20 vol. % based on the total volume of the H₂S-containing feed gas stream. In some embodiments, the volume ratio of the inert gas to the H₂S present in the H₂S-containing feed gas stream is in a range of about 1:3 to about 1:200, such as about 1:4 to about 1:150, about 1:5 to about 1:100, about 1:10 to about 1:50, or about 1:20. In further embodiments, the volume ratio of the inert gas to the H₂S present in the H₂S-containing feed gas stream is about 1:10.

In some embodiments, the inert gas is nitrogen. In some embodiments, the concentration of the nitrogen present in the H₂S-containing feed gas stream is in a range of about 0 to about 20 vol. %, such as about 1 to about 17 vol. %, about 3 to about 14 vol. %, about 5 to about 11 vol. %, or about 8 vol. % based on the total volume of the H₂S-containing feed gas stream. In further embodiments, the concentration of the nitrogen present in the H₂S-containing feed gas stream is in a range of about 20 vol. % based on the total volume of the H₂S-containing feed gas stream. In some embodiments, the volume ratio of the nitrogen to the H₂S present in the H₂S-containing feed gas stream is in a range of about 1:3 to about 1:200, such as about 1:4 to about 1:150, about 1:5 to about 1:100, about 1:10 to about 1:50, or about 1:20. In further embodiments, the volume ratio of the nitrogen to the H₂S present in the H₂S-containing feed gas stream is about 1:10.

In some embodiments, the reactor is selected from the group consisting of a fixed-bed reactor, a trickle-bed reactor, a moving bed reactor, a rotating bed reactor, a fluidized bed reactor, and a slurry reactor. In an embodiment, the reactor is a fixed-bed reactor in the form of a cylindrical reactor. In some embodiments, the MoS₂ catalyst is supportably retained within a housing part of the reactor permitting fluid flow therethrough.

In some embodiments, the method for converting H₂S includes passing the H₂S-containing feed gas stream through the reactor to contact the H₂S-containing feed gas stream with the MoS₂ catalyst at a temperature of about 500 to about 1000° C., such as about 550 to about 950° C., about 600 to about 900° C., about 600 to about 850° C., about 650 to about 800° C., about 700 to about 750° C., or about 500° C., about 550° C., about 600° C., about 650° C., about 700° C., about 750° C., about 800° C., about 850° C., about 900° C., or about 950° C., thereby converting at least a portion of the H₂S to H₂ and S and producing a spent catalyst in-situ and a residue gas stream leaving the reactor. In further embodiments, the passing the H₂S-containing feed gas stream through the reactor is performed at a temperature of about 500° C. In further embodiments, the passing the H₂S-containing feed gas stream through the reactor is performed at a temperature of about 600° C. In further embodiments, the passing the H₂S-containing feed gas stream through the reactor is performed at a temperature of about 700° C. In further embodiments, the passing the H₂S-containing feed gas stream through the reactor is performed at a temperature of about 800° C. In further embodiments, the passing the H₂S-containing feed gas stream through the reactor is performed at a temperature of about 900° C.

In some embodiments, the passing the H₂S-containing feed gas stream through the reactor is carried out at a spacetime of about 0.001 to about 10 grams seconds per milliliter (g s mL⁻¹), such as about 0.001 to about 8 g s mL⁻¹, about 0.01 to about 5 g s mL⁻¹, about 0.02 to about 1 g s mL⁻¹, about 0.03 to about 0.1 g s mL⁻¹, or about 0.03 g s mL⁻¹, at a temperature of about 700° C. In further embodiments, the passing the H₂S-containing feed gas stream through the reactor is carried out at a spacetime of about 0.03 g s mL⁻¹.

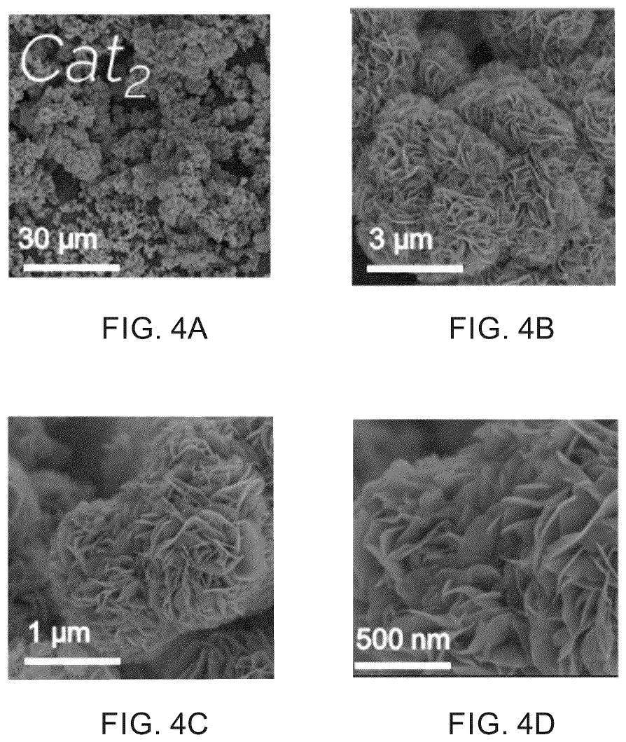

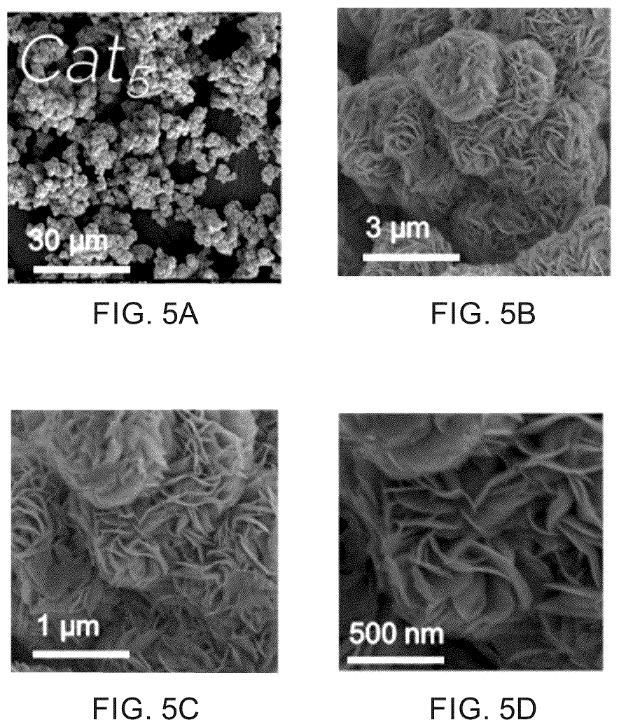

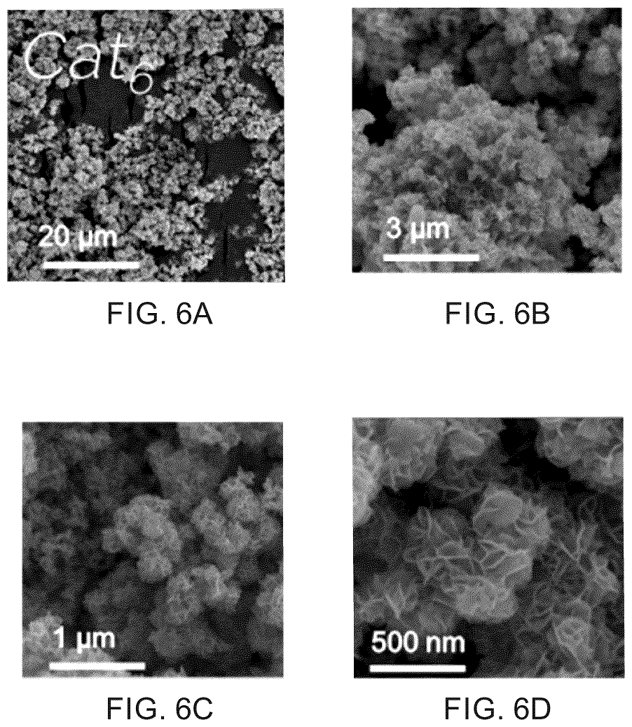

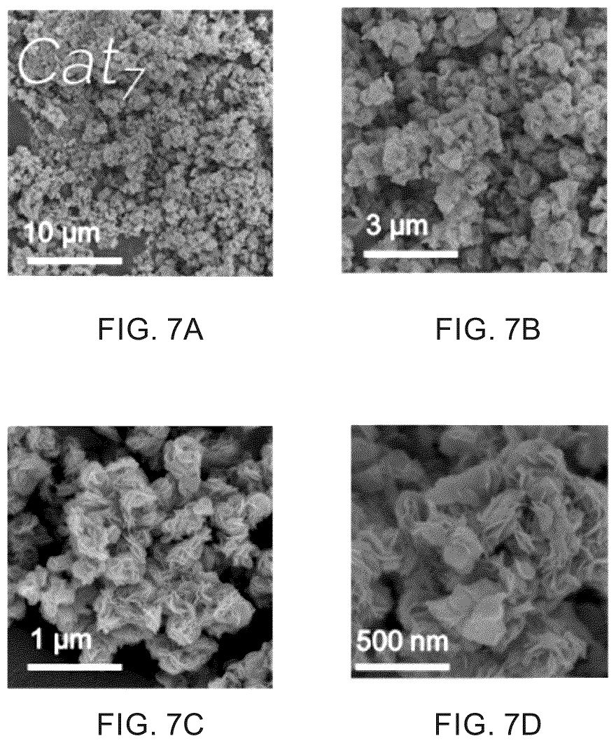

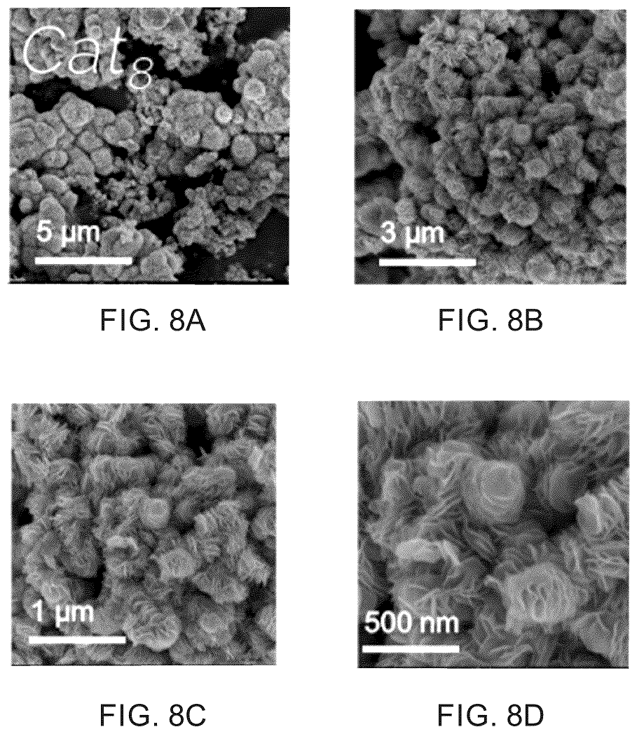

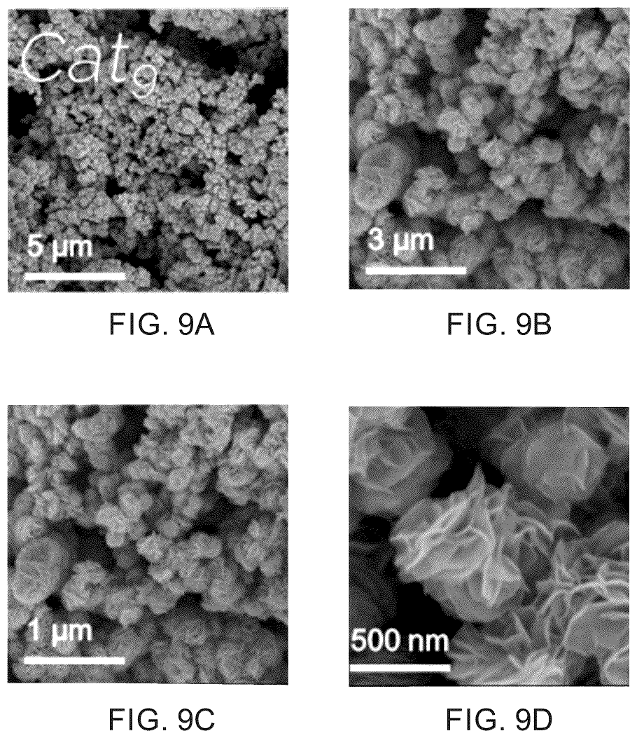

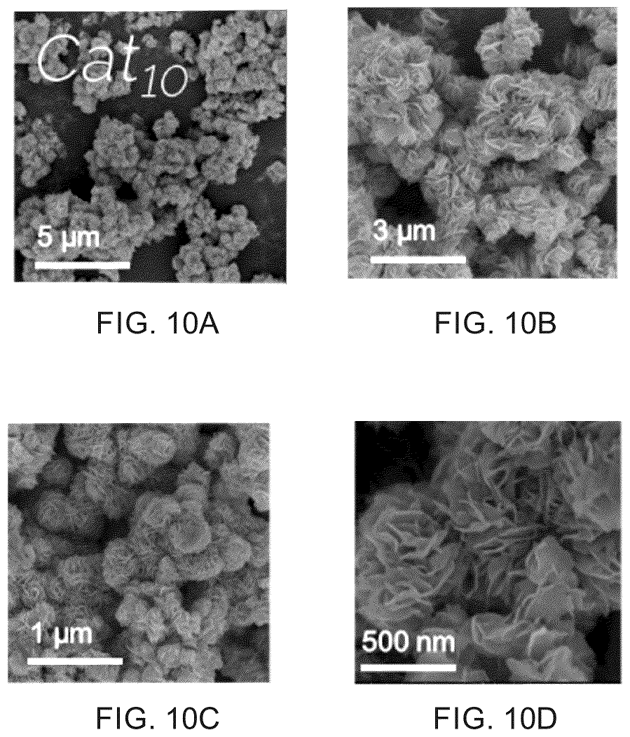

In some embodiments, the MoS₂ catalyst is in the form of a flower-like nanosheet microsphere or a nanosheet. In further embodiments, the MoS₂ catalyst is in the form of a flower-like nanosheet microsphere, as depicted in FIGS. 4A to 10D. In some embodiments, the flower-like nanosheet microsphere of the MoS₂ catalyst has an average particle size of about 200 to about 2000 nanometers (nm), such as about 250 to about 1800 nm, about 300 to about 1600 nm, about 350 to about 1400 nm, about 400 to about 1200 nm, about 450 to about 1000 nm, about 500 to about 800 nm, or about 550 to about 600 nm. In further embodiments, the flower-like nanosheet microsphere of the MoS₂ catalyst has an average particle size of about 400 to about 700 nm. In further embodiments, the flower-like nanosheet microsphere of the MoS₂ catalyst has an average particle size of about 500 to about 600 nm. In further embodiments, the flower-like nanosheet microsphere of the MoS₂ catalyst has an average particle size of about 550 nm. In some embodiments, the flower-like nanosheet microsphere of the MoS₂ catalyst has a uniform shape.

In some embodiments, each flower-like nanosheet microsphere comprises a hollow spherical core and a plurality of interconnected nanosheets growing perpendicular to a surface of the hollow spherical core. In some embodiments, the hollow spherical core of the flower-like nanosheet microsphere has an average diameter of about 20 to about 800 nm, such as about 40 to about 700 nm, about 60 to about 600 nm, about 80 to about 500 nm, about 100 to about 400 nm, about 120 to about 300 nm, about 140 to about 200 nm, or about 160 nm. In further embodiments, the hollow spherical core of the flower-like nanosheet microsphere has an average diameter of about 120 to about 200 nm. In further embodiments, the hollow spherical core of the flower-like nanosheet microsphere has an average diameter of about 140 to about 180 nm. In further embodiments, the hollow spherical core of the flower-like nanosheet microsphere has an average diameter of about 160 nm.

In some preferred embodiments, the plurality of interconnected nanosheets have an average width of about 50 to about 800 nm, such as about 70 to about 700 nm, about 90 to about 600 nm, about 110 to about 500 nm, about 130 to about 400 nm, about 150 to about 300 nm, or about 200 nm. In further embodiments, the plurality of interconnected nanosheets have an average width of about 200 to about 500 nm. In further embodiments, the plurality of interconnected nanosheets have an average width of about 250 to about 450 nm. In further embodiments, the plurality of interconnected nanosheets have an average width of about 300 to about 400 nm. In further embodiments, the plurality of interconnected nanosheets have an average width of about 350 nm.

In some more preferred embodiments, the plurality of interconnected nanosheets has an average thickness of about 0.5 to about 100 nm, such as about 1 to about 80 nm, about 3 to about 60 nm, about 5 to about 40 nm, about 7 to about 20 nm, or about 5 nm, about 10 nm, about 15 nm, about 20 nm, about 25 nm, about 30 nm, about 35 nm, about 40 nm, about 40 nm, about 45 nm, about 50 nm, about 55 nm, about 60 nm, about 65 nm, about 70 nm, or about 75 nm. In further embodiments, the plurality of interconnected nanosheets has an average thickness of about 10 to about 80 nm. In further embodiments, the plurality of interconnected nanosheets has an average thickness of about 10 to about 70 nm. In further embodiments, the plurality of interconnected nanosheets has an average thickness of about 10 to about 60 nm. In further embodiments, the plurality of interconnected nanosheets has an average thickness of about 10 to about 50 nm. In further embodiments, the plurality of interconnected nanosheets has an average thickness of about 10 to about 40 nm. In further embodiments, the plurality of interconnected nanosheets has an average thickness of about 10 to about 30 nm. In further embodiments, the plurality of interconnected nanosheets has an average thickness of about 10 to about 20 nm.

In some embodiments, the flower-like nanosheet microsphere of the MoS₂ catalyst has a surface area in a range of about 5 to about 100 square meters per gram (m²/g), such as about 10 to about 80 m²/g, about 20 to about 60 m²/g, about 30 to about 40 m²/g, or about 10 m²/g, about 20 m²/g, about 30 m²/g, about 40 m²/g, about 50 m²/g, about 60 m²/g, about 70 m²/g, about 80 m²/g, or about 90 m²/g, as determined by a Brunauer-Emmett-Teller (BET) method. In some embodiments, the flower-like nanosheet microsphere of the MoS₂ catalyst has a surface area of about 22 m²/g, as determined by the Brunauer-Emmett-Teller (BET) method. In some embodiments, the flower-like nanosheet microsphere of the MoS₂ catalyst has a surface area of about 32 m²/g, as determined by the Brunauer-Emmett-Teller (BET) method. In some embodiments, the flower-like nanosheet microsphere of the MoS₂ catalyst has a surface area of about 42 m²/g, as determined by the Brunauer-Emmett-Teller (BET) method.

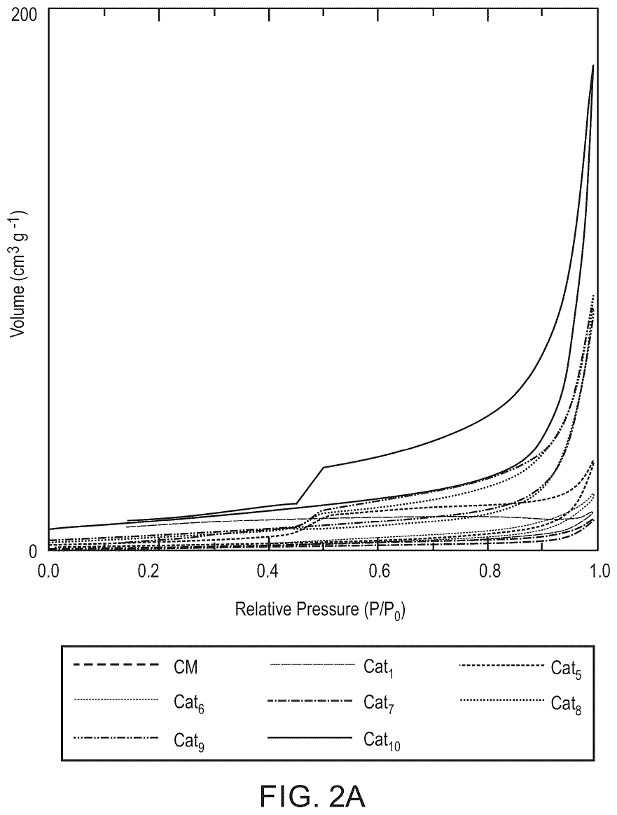

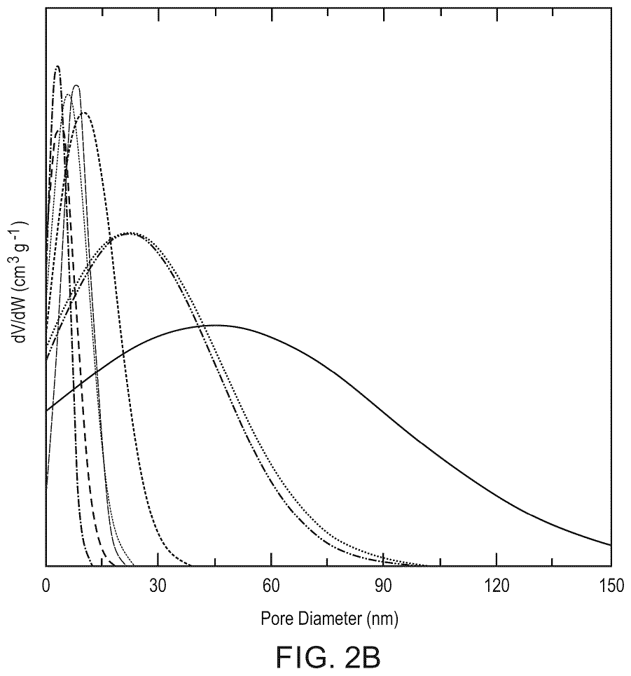

In some embodiments, the flower-like nanosheet microsphere of the MoS₂ catalyst has a pore volume in a range of about 20 to about 250 cubic centimeters per gram (cm³/g), such as about 50 to about 200 cm³/g, about 100 to about 150 cm³/g, or about 85 cm³/g, about 105 cm³/g, about 125 cm³/g, about 145 cm³/g, about 165 cm³/g, or about 185 cm³/g, at a relative pressure of about 1, as determined by N₂ adsorption/desorption isotherms and depicted in FIG. 2A. In further embodiments, the flower-like nanosheet microsphere of the MoS₂ catalyst has a pore of about 110 to about 140 cm³/g at a relative pressure of about 1, as determined by the N₂ adsorption/desorption isotherms and depicted in FIG. 2A. In further embodiments, the flower-like nanosheet microsphere of the MoS₂ catalyst has a pore of about 120 to about 130 cm³/g at a relative pressure of about 1, as determined by the N₂ adsorption/desorption isotherms and depicted in FIG. 2A. In further embodiments, the flower-like nanosheet microsphere of the MoS₂ catalyst has a pore of about 125 cm³/g at a relative pressure of about 1, as determined by the N₂ adsorption/desorption isotherms and depicted in FIG. 2A.

In some embodiments, the flower-like nanosheet microsphere of the MoS₂ catalyst has an average pore diameter of about 2 to about 90 nm, such as about 5 to about 70 nm, about 10 to about 50 nm, about 15 to about 30 nm, or about 10 nm, about 20 nm, about 30 nm, about 40 nm, about 50 nm, about 60 nm, about 70 nm, or about 80 nm as depicted in FIG. 2B. In further embodiments, the flower-like nanosheet microsphere of the MoS₂ catalyst has an average pore diameter of about 10 to about 50 nm, as depicted in FIG. 2B. In further embodiments, the flower-like nanosheet microsphere of the MoS₂ catalyst has an average pore diameter of about 15 to about 25 nm, as depicted in FIG. 2B. In further embodiments, the flower-like nanosheet microsphere of the MoS₂ catalyst has an average pore diameter of about 20 nm, as depicted in FIG. 2B.

The crystalline structure of the flower-like nanosheet microsphere of the MoS₂ catalyst is characterized by X-ray diffraction (XRD). In some embodiments, the XRD patterns are collected in a Rigaku diffractometer (Miniflex) equipped with a Cu-Kα radiation source (2=0.15406 nm) for a 20 range extending between about 5° and about 90°, such as about 10° and about 80°, about 20° and about 70°, about 30° and about 60°, about 40° and about 50°, at an angular rate of about 0.005 to about 0.04°/s, about 0.01 to about 0.03°/s, or about 0.02°/s. In further embodiments, the XRD patterns are collected over a 20 range extending between about 5° and about 90° at an angular rate of about 0.02°/s.

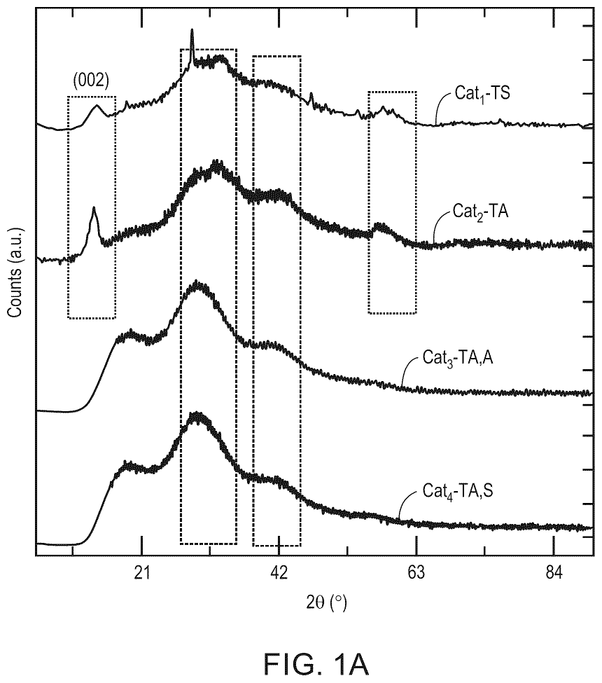

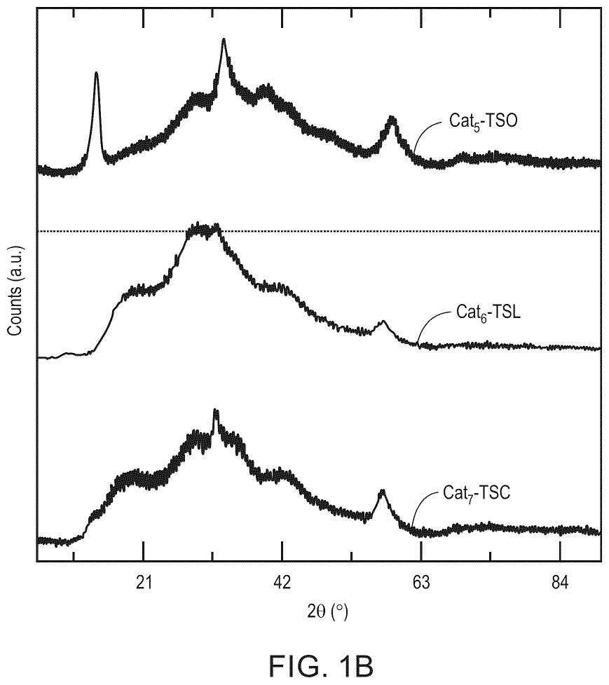

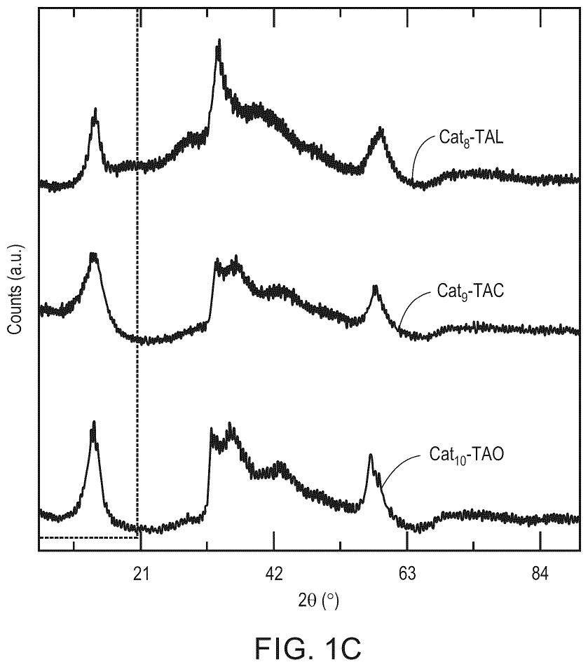

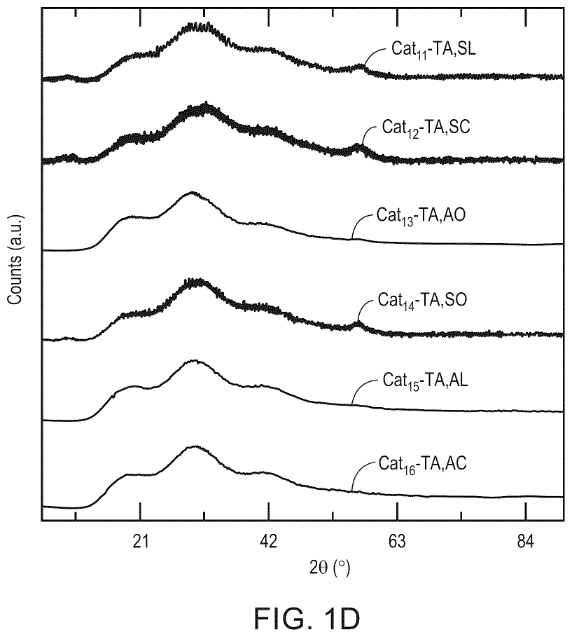

FIG. 1A depicts XRD patterns of MoS₂ catalyst samples Cat₁ to Cat₄ prepared by a hydrothermal method. In some embodiments, the MoS₂ catalyst samples Cat₁ to Cat₄ prepared by the hydrothermal method contain a plurality of flower-like nanosheet microsphere crystalline structures. In some embodiments, the MoS₂ catalyst samples Cat₁ and Cat₂ have a first intense peak with a 2 theta (θ) value in a range of about 12° to about 16°, such as about 13° to about 15°, or about 14° corresponding to the (002) lattice plane of the MoS₂ hexagonal structure (JCPDS card No. 37-1492, incorporated herein by reference in its entirety). In some embodiments, the MoS₂ catalyst samples Cat₁ and Cat₂ have a second intense peak with a 2θ value in a range of about 30° to about 34°, such as about 31° to about 33°, or about 32° corresponding to the (100) lattice plane of the MoS₂ hexagonal structure. In some embodiments, the MoS₂ catalyst samples Cat₁ and Cat₂ have a third intense peak with a 20 value in a range of about 37° to about 41°, such as about 38° to about 40°, or about 39° corresponding to the (103) lattice plane of the MoS₂ hexagonal structure. In some embodiments, the MoS₂ catalyst samples Cat₁ and Cat₂ have a fourth intense peak with a 20 value in a range of about 56° to about 60°, such as about 57° to about 59°, or about 58° corresponding to the (110) lattice plane of the MoS₂ hexagonal structure. In further preferred embodiments, the MoS₂ catalyst samples Cat₁ and Cat₂ have peaks with a 20 value of about 14°, about 32°, about 39°, and about 58°, corresponding to the (002), (100), (103), and (110) lattice planes of the MoS₂ hexagonal structure (JCPDS card No. 37-1492).

In some embodiments, the MoS₂ catalyst samples Cat₃ and Cat₄ have peaks with a 20 value in a range of about 30° to about 34°, such as about 31° to about 33°, or about 32°; and about 37° to about 41°, such as about 38° to about 40°, or about 39°, corresponding to the (100) and (103) lattice plane of the MoS₂ hexagonal structure.

In some embodiments, the MoS₂ catalyst samples Cat₈ to Cat₁₀ prepared from ammonium heptamolybdate and thiourea by the hydrothermal method have peaks with a 20 value of about 12° to about 16°, or about 14°; about 30° to about 34°, or about 32°; about 37° to about 41°, or about 39°; about 56° to about 60°, or about 58°, corresponding to the (002), (100), (103), and (110) lattice planes of the MoS₂ hexagonal structure, respectively. In some embodiments, the Cat₈ to Cat₁₀ MoS₂ catalysts show enhanced diffraction peaks on the (002) and (103) lattice planes compared to that of the Cat₁ to Cat₄ MoS₂ catalysts.

In some embodiments, the MoS₂ catalyst is in the form of a nanosheet prepared by an exfoliation method. In some embodiments, the nanosheet of the MoS₂ catalyst has an average size of about 1 to about 800 nm, such as about 5 to about 700 nm, about 10 to about 600 nm, about 20 to about 500 nm, about 40 to about 400 nm, about 80 to about 300 nm, about 160 to about 200 nm, or about 80 nm, about 180 nm, about 280 nm, about 380 nm, about 480 nm, about 580 nm, or about 680 nm. In further embodiments, the nanosheet of the MoS₂ catalyst has an average size of about 120 to about 300 nm. In further embodiments, the nanosheet of the MoS₂ catalyst has an average size of about 160 to about 200 nm. In further embodiments, the nanosheet of the MoS₂ catalyst has an average size of about 180 nm. In some embodiments, the nanosheet of the MoS₂ catalyst has an average thickness of about 0.1 to about 50 nm, such as about 0.5 to about 40 nm, about 1 to about 30 nm, about 2 to about 20 nm, about 3 to about 10 nm, about 4 to about 8 nm, about 5 to about 6 nm, or about 5.5 nm. In further embodiments, the nanosheet of the MoS₂ catalyst has an average thickness of about 3 to about 7 nm. In further embodiments, the nanosheet of the MoS₂ catalyst has an average thickness of about 5 to about 6 nm. In further embodiments, the nanosheet of the MoS₂ catalyst has an average thickness of about 5.5 nm.

Optionally, the MoS₂ catalyst maybe supported on a support material to form a catalyst composite. In some embodiments, the support material is selected from the group consisting of a metal oxide, a carbon material, a silica material, and combinations thereof.

In some embodiments, the carbon material includes, but is not limited to, carbon nanotubes, carbon nanobuds, carbon nanoscrolls, carbon dots, activated carbon, carbon black, graphene, graphene oxide, reduced graphene oxide, and nanodiamonds. In some embodiments, the carbon material is selected from the group consisting of graphene, graphene oxide, reduced graphene oxide, carbon nanotubes, carbon dots, activated carbon, and mixtures thereof. In some embodiments, the metal oxide includes, but is not limited to, a metal organic framework (MOF), a zeolitic imidazolate framework (ZIF), and an inorganic oxide. In some embodiments, the silica material includes, but is not limited to, a clay and a silica-containing covalent organic polymer (COP). Examples of the catalyst composite include, but are not limited to, a metal oxide-supported MoS₂ catalyst, a carbon nanotube-supported MoS₂ catalyst, an activated carbon-supported MoS₂ catalyst, a MOF-supported MoS₂ catalyst, a ZIF-supported MoS₂ catalyst, and a COP-supported MoS₂ catalyst.

In some embodiments, the carbon material is carbon nanotubes. The carbon nanotubes may be any suitable carbon nanotubes known to one of ordinary skill in the art. Carbon nanotubes may be classified by structural properties such as the number of walls or the geometric configuration of the atoms that make up the nanotube. Classified by their number of walls, the carbon nanotubes can be single-walled carbon nanotubes (SWCNT) which have only one layer of carbon atoms arranged into a tube, or multi-walled carbon nanotubes (MWCNT), which have more than one single-layer tube of carbon atoms arranged so as to be nested, one tube inside another, each tube sharing a common orientation. Closely related to MWNTs are carbon nanoscrolls. Carbon nanoscrolls are structures similar in shape to a MWCNT, but made of a single layer of carbon atoms that has been rolled onto itself to form a multi-layered tube with a free outer edge on the exterior of the nanoscroll and a free inner edge on the interior of the scroll and open ends. The end-on view of a carbon nanoscroll has a spiral-like shape. For the purposes of this disclosure, carbon nanoscrolls are considered a type of MWCNT. Classified by the geometric configuration of the atoms that make up the nanotube, carbon nanotubes can be described by a pair of integer indices n and m. The indices n and m denote the number of unit vectors along two directions in the honeycomb crystal lattice of a single layer of carbon atoms. If m=0, the nanotubes are called zigzag type nanotubes. If n=m, the nanotubes are called armchair type nanotubes. Otherwise, they are called chiral type nanotubes. In some embodiments, the carbon nanotubes are metallic. In some embodiments, the carbon nanotubes are semiconducting. In some embodiments, the carbon nanotubes are SWCNTs. In some embodiments, the carbon nanotubes are MWCNTs. In some embodiments, the carbon nanotubes are carbon nanoscrolls. In some embodiments, the carbon nanotubes are zigzag type nanotubes. In some embodiments, the carbon nanotubes are armchair type nanotubes. In some embodiments, the carbon nanotubes are chiral type nanotubes. In some embodiments, the particles of a carbon nanomaterial are a single type of particle as described herein. In this context, “a single type of particle” refers to particles of a single carbon nanomaterial, particles which have substantially the same shape, particles which have substantially the same size, or any combination of these.

In some embodiments, the metal organic framework is a zeolitic imidazolate framework. In some embodiments, the zeolitic material has a three-dimensional framework that is at least one zeolite framework selected from the group consisting of a 4-membered ring zeolite framework, a 6-membered ring zeolite framework, a 10-membered ring zeolite framework, and a 12-membered ring zeolite framework. The zeolite may have a natrolite framework (e.g., gonnardite, natrolite, mesolite, paranatrolite, scolecite, and tetranatrolite), edingtonite framework (e.g., edingtonite and kalborsite), thomsonite framework, analcime framework (e.g., analcime, leucite, pollucite, and wairakite), phillipsite framework (e.g., harmotome), gismondine framework (e.g., amicite, gismondine, garronite, and gobbinsite), chabazite framework (e.g., chabazite-series, herschelite, willhendersonite, and SSZ-13), faujasite framework (e.g., faujasite-series, Linde type X, and Linde type Y), mordenite framework (e.g., maricopaite and mordenite), heulandite framework (e.g., clinoptilolite and heulandite-series), stilbite framework (e.g., barrerite, stellerite, and stilbite-series), brewsterite framework, or cowlesite framework. Examples of suitable metal organic frameworks include, but are not limited to, isoreticular metal organic framework-3 (IRMOF-3), MOF-69A, MOF-69B, MOF-69C, MOF-70, MOF-71, MOF-73, MOF-74, MOF-75, MOF-76, MOF-77, MOF-78, MOF-79, MOF-80, DMOF-1-NH2, UMCM-1-NH2, MOF-69-80, ZIF-1, ZIF-2, ZIF-3, ZIF-4, ZIF-5, ZIF-6, ZIF-7, ZIF-9, ZIF-10, ZIF-11, ZIF-12, ZIF-14, ZIF-20, ZIF-21, ZIF-22, ZIF-23, ZIF-25, ZIF-60, ZIF-61, ZIF-62, ZIF-63, ZIF-64, ZIF-65, ZIF-66, ZIF-67, ZIF-68, ZIF-69, ZIF-70, ZIF-71, ZIF-72, ZIF-73, ZIF-74, ZIF-75, ZIF-76, ZIF-77, ZIF-78, ZIF-79, ZIF-80, ZIF-81, ZIF-82, ZIF-90, ZIF-91, ZIF-92, ZIF-93, ZIF-94, ZIF-96, ZIF-97, ZIF-100, ZIF-108, ZIF-303, ZIF-360, ZIF-365, ZIF-376, ZIF-386, ZIF-408, ZIF-410, ZIF-412, ZIF-413, ZIF-414, ZIF-486, ZIF-516, ZIF-586, ZIF-615, and ZIF-725.

In some embodiments, the metal oxide is an inorganic metal oxide selected from the group consisting of aluminum oxide, zinc oxide, copper oxide, nickel oxide, cobalt oxide, manganese oxide, chromium oxide, cadmium oxide, magnesium oxide, zirconium oxide, and mixtures thereof.

In some embodiments, the support material is aluminum oxide. In some embodiments, the aluminum oxide is gamma (γ) aluminum oxide. Examples of aluminum oxide include, but are not limited to, alumina, silica-alumina, alumina-titania, alumina-zirconia, alumina-boria, phosphorus-alumina, silica alumina-boria, phosphorus-alumina-boria, phosphorus-alumina-silica, silica-alumina-titania, silica-alumina-zirconia, or mixtures thereof.

In some embodiments, the support material is present in the form of particles. The particles can be any shape known to one of ordinary skill in the art. Examples of suitable shapes the support material particles may take include spheres, spheroids, lentoids, ovoids, solid polyhedra such as tetrahedra, cubes, octahedra, icosahedra, dodecahedra, rectangular prisms, triangular prisms (also known as nanotriangles), nanoplatelets, nanodisks, nanotubes, blocks, flakes, discs, granules, angular chunks, or combinations thereof.

In some embodiments, the support material particles have uniform shape. In one embodiment, the shape is uniform and at least about 90% of the support material particles are spherical or substantially circular, and less than about 10% are polygonal. In further embodiments, the support material particles have non-uniform shape. In one embodiment, the shape is non-uniform and less than about 90% of the material particles are spherical or substantially circular, and greater than about 10% are polygonal.

In some embodiments, the conversion of H₂S to H₂ and S is about 7 to about 20% based on an initial concentration of the H₂S in the H₂S-containing feed gas stream at a temperature of about 700° C. In further embodiments, the conversion of H₂S to H₂ and S is about 8 to about 18%, such as about 9 to about 16%, about 10 to about 14%, or about 11 to about 12%, based on the initial concentration of the H₂S in the H₂S-containing feed gas stream at a temperature of about 700° C. In some embodiments, the conversion of H₂S to H₂ and S is about 8% based on an initial concentration of the H₂S in the H₂S-containing feed gas stream at a temperature of about 700° C. In some embodiments, the conversion of H₂S to H₂ and S is about 9% based on an initial concentration of the H₂S in the H₂S-containing feed gas stream at a temperature of about 700° C. In some embodiments, the conversion of H₂S to H₂ and S is about 10% based on an initial concentration of the H₂S in the H₂S-containing feed gas stream at a temperature of about 700° C. In some embodiments, the conversion of H₂S to H₂ and S is about 11% based on an initial concentration of the H₂S in the H₂S-containing feed gas stream at a temperature of about 700° C. In some embodiments, the conversion of H₂S to H₂ and S is about 12% based on an initial concentration of the H₂S in the H₂S-containing feed gas stream at a temperature of about 700° C. In some embodiments, the conversion of H₂S to H₂ and S is about 13% based on an initial concentration of the H₂S in the H₂S-containing feed gas stream at a temperature of about 700° C. In some embodiments, the conversion of H₂S to H₂ and S is about 14% based on an initial concentration of the H₂S in the H₂S-containing feed gas stream at a temperature of about 700° C. In some embodiments, the conversion of H₂S to H₂ and S is about 15% based on an initial concentration of the H₂S in the H₂S-containing feed gas stream at a temperature of about 700° C.

In some embodiments, the method for converting H₂S further includes regenerating the MoS₂ catalyst by washing the spent catalyst with two or more solvents and drying. In some embodiments, the two or more solvents are selected from the group consisting of aromatics, alkanes, ketones, glycols, chlorinated solvents, esters, ethers, amines, nitriles, aldehydes, phenols, amides, carboxylic acids, alcohols, furans, polar protic solvents, polar aprotic solvents, water, and mixtures thereof. In some embodiments, the two or more solvents are polar protic solvents, including but not limited to, water, acetone, N-methyl 2-pyrrolidone (NMP), acetonitrile, dimethylformamide (DMF), dimethyl sulfoxide (DMSO), isopropanol, methanol, and mixtures thereof. In some embodiments, the two or more solvents are water and NMP. In some embodiments, the drying the spent catalyst is carried out at a temperature of about 50 to about 100° C., such as about 55 to about 95° C., about 60 to about 90° C., about 65 to about 85° C., about 70 to about 80° C., or about 75° C. In further embodiments, the drying the spent catalyst is carried out at a temperature of about 75° C.

Also provided in the present disclosure is a method for preparing the MoS₂ catalyst by a hydrothermal method. The hydrothermal method includes mixing a molybdenum salt and a reducing agent in water to form a first mixture. In some embodiments, the mixing is carried out at a mixing speed of about 100 to about 2000 revolutions per minute (rpm), such as about 150 to about 1800 rpm, about 200 to about 1600 rpm, about 250 to about 1400 rpm, about 300 to about 1200 rpm, about 350 to about 1000 rpm, about 400 to about 800 rpm, or about 500 rpm. The mixing may be carried out manually or with the help of a stirrer. In further embodiments, the mixing is performed at room temperature. In some embodiments, the molybdenum salt is selected from the group consisting of sodium molybdate (Na₂MoO₄), potassium molybdate (K₂MoO₄), calcium molybdate (CaMoO₄), barium molybdate (BaMoO₄), lithium molybdate (Li₂MoO₄), magnesium molybdate (MgMoO₄), zinc molybdate (ZnMoO₄), ammonium heptamolybdate ((NH4)₆Mo₇O₂₄), ammonium orthomolybdate ((NH4)₂MoO₄), hydrates thereof, and mixtures thereof. In some embodiments, the molybdenum salt is sodium molybdate or ammonium heptamolybdate. In some embodiments, the reducing agent is selected from the group consisting of citric acid, oxalic acid, ascorbic acid, hydrates thereof, and mixtures thereof. The reducing agent can improve the crystallinity and flower-like structure of the MoS₂ catalyst by growing the nanosheets along the (002) and (103) lattice planes in the formation of the flower-like nanosheet microsphere. In some embodiments, a molar ratio of the molybdenum salt and the reducing agent is in a range of about 5000:1 to about 50:1, such as about 4000:1 to about 100:1, about 3000:1 to about 200:1, about 2000:1 to about 400:1, or about 1000:1 to about 800:1.

In some embodiments, the molybdenum salt is ammonium heptamolybdate, and the reducing agent is oxalic acid. In further embodiments, the molar ratio of ammonium heptamolybdate and the oxalic acid is in a range of about 5000:1 to about 50:1, such as about 4000:1 to about 100:1, about 3000:1 to about 200:1, about 2000:1 to about 400:1, or about 1000:1 to about 800:1. In further embodiments, the molar ratio of ammonium heptamolybdate and the oxalic acid is about 3000:1 to about 100:1. In further embodiments, the molar ratio of ammonium heptamolybdate and the oxalic acid is about 2000:1 to about 400:1. In further embodiments, the molar ratio of ammonium heptamolybdate and the oxalic acid is about 1000:1 to about 800:1. In further embodiments, the molar ratio of ammonium heptamolybdate and the oxalic acid is about 900:1.

In some embodiments, the water is selected from the group consisting of tap water, distilled water, bidistilled water, deionized water, deionized distilled water, and reverse osmosis water. In further embodiments, the water is deionized water.

The hydrothermal method further includes mixing a sulfur precursor in water to form a second mixture. In some embodiments, the sulfur precursor is selected from the group consisting of thioacetamide (CH₃CSNH₂) and thiourea (CH₄N₂S), hydrates thereof, and mixtures thereof. In some embodiments, the mixing is carried out at a mixing speed of about 100 to about 2000 rpm, such as about 150 to about 1800 rpm, about 200 to about 1600 rpm, about 250 to about 1400 rpm, about 300 to about 1200 rpm, about 350 to about 1000 rpm, about 400 to about 800 rpm, or about 500 rpm. The mixing may be carried out manually or with the help of a stirrer. In further embodiments, the mixing is performed at room temperature. In some embodiments, a molar ratio of the molybdenum salt and the sulfur precursor is in a range of about 10:1 to about 1:100, such as about 5:1 to about 1:50, about 1:1 to about 1:20, about 1:2 to about 1:10, or about 1:4 to about 1:6. In further embodiments, the molar ratio of the molybdenum salt and the sulfur precursor is about 1:1 to about 1:10. In further embodiments, the molar ratio of the molybdenum salt and the sulfur precursor is about 1:2 to about 1:10. In further embodiments, the molar ratio of the molybdenum salt and the sulfur precursor is about 1:4 to about 1:10. In further embodiments, the molar ratio of the molybdenum salt and the sulfur precursor is about 1:6 to about 1:10.

In some embodiments, the molybdenum salt is ammonium heptamolybdate, and the sulfur precursor is thiourea. In further embodiments, the molar ratio of the ammonium heptamolybdate and the thiourea is in a range of about 10:1 to about 1:100, such as about 5:1 to about 1:50, about 1:1 to about 1:20, about 1:2 to about 1:10, or about 1:4 to about 1:6. In further embodiments, the molar ratio of the ammonium heptamolybdate and the thiourea is about 1:2 to about 1:10. In further embodiments, the molar ratio of the ammonium heptamolybdate and the thiourea is about 1:2 to about 1:10. In further embodiments, the molar ratio of the ammonium heptamolybdate and the thiourea is about 1:4 to about 1:10. In further embodiments, the molar ratio of the ammonium heptamolybdate and the thiourea is about 1:6 to about 1:10.

The hydrothermal method further includes mixing the first mixture with the second mixture to form a reaction mixture, and heating the reaction mixture at a temperature of about 160 to about 220° C., such as about 170 to about 210° C., about 180 to about 200° C., about 190 to about 200° C., or about 200° C., to form a crude product in the form of a precipitate.

The hydrothermal method further includes separating the crude product from the reaction mixture, washing and drying. The crude product may be separated from the reaction mixture via centrifugation, filtration, evaporation, or by a method used or known in the art. In further embodiments, the crude product after separation is dried at a temperature of about 60 to about 120° C., such as about 70 to about 110° C., about 80 to about 100° C., or about 90° C. for a period of about 12 to about 16 hours to remove any water molecules and volatile components in the crude product. In addition, the crude product may be dried in a heating device such as ovens, hot plates, heating mantles and tapes, oil baths, salt baths, sand baths, air baths, hot-tube furnaces, hot-air guns, and microwave ovens.

Also provided in the present disclosure is a method for preparing metal sulfides, including but not limited to, hafnium disulfide (HfS₂), platinum disulfide (PtS₂), tantalum disulfide (TaS₂), vanadium disulfide (VS₂), niobium disulfide (NbS₂), zirconium disulfide (ZrS₂), and titanium disulfide (TiS₂) by the hydrothermal method as described herein. A density functional theory (DFT) calculation is performed to determine the H₂S binding energy (ΔE_{H2S}) and S₂ binding energy (ΔE_{S2}). In some embodiments, the metal sulfide prepared via the hydrothermal method has a H₂S binding energy of about −1.5 to about −0.5 electronvolt (eV), such as about −1.3 to about −0.6 eV, about −1.1 to about −0.7 eV, about −0.9 to about −0.8 eV, or about −0.75 eV. In some embodiments, the metal sulfide is TaS₂. In further embodiments, the TaS₂ has a H₂S binding energy of about-0.53 eV. In some embodiments, the metal sulfide is VS₂. In further embodiments, the VS₂ has a H₂S binding energy of about −0.72 eV. In some embodiments, the metal sulfide is NbS₂. In further embodiments, the NbS₂ has a H₂S binding energy of about −0.4 eV. In some embodiments, the metal sulfide is TiS₂. In further embodiments, the TiS₂ has a H₂S binding energy of about −0.3 eV.

In some further embodiments, the metal sulfide prepared via the hydrothermal method has a S₂ binding energy of about −3 to about −0.5 eV, such as about −3 to about −1 eV, about −3 to about −1.5 eV, about −3 to about −2 eV, or about −2.5 eV. In some embodiments, the metal sulfide is TaS₂. In further embodiments, the TaS₂ has a S₂ binding energy of about −2.3 eV. In some embodiments, the metal sulfide is VS₂. In further embodiments, the VS₂ has a S₂ binding energy of about −2.4 eV. In some embodiments, the metal sulfide is NbS₂. In further embodiments, the NbS₂ has a S₂ binding energy of about −1.5 eV. In some embodiments, the metal sulfide is TiS₂. In further embodiments, the TiS₂ has a S₂ binding energy of about −2.7 eV.

Also provided in the present disclosure is a method for preparing the MoS₂ catalyst by an exfoliation method. The exfoliation method includes dispersing a bulk MoS₂ material in a solvent to form a suspension and sonicating at a temperature of about 0 to about 100° C., such as about 0 to about 50° C., about 10 to about 40° C., or about 20 to about 30° C. In some embodiments, the solvent is selected from the group consisting of an aromatic solvent, a ketone solvent, a glycol solvent, an ester solvent, an amine solvent, an amide solvent, an alcohol solvent, a polar protic solvent, a polar aprotic solvent, water, and mixtures thereof. In some embodiments, the solvent is a polar protic solvent. In some embodiments, the bulk MoS₂ material is present in the polar protic solvent in an amount of about 0.1 to about 20 milligrams per milliliter (mg/mL), such as about 1 to about 15 mg/mL, about 3 to about 10 mg/mL, about 4 to about 5 mg/mL, or about 1 mg/mL, about 3 mg/mL, about 5 mg/mL, about 7 mg/mL, about 9 mg/mL, about 11 mg/mL, about 13 mg/mL, or about 15 mg/mL. In some embodiments, the polar protic solvent is N-methyl 2-pyrrolidone (NMP). In further embodiments, the bulk MoS₂ material is present in the polar protic solvent in an amount of about 5 mg/mL. In some embodiments, the bulk MoS₂ material is present in NMP in an amount of about 0.1 to about 20 mg/mL, about 1 to about 15 mg/mL, about 3 to about 10 mg/mL, about 4 to about 5 mg/mL, or about 1 mg/mL, about 3 mg/mL, about 5 mg/mL, about 7 mg/mL, about 9 mg/mL, about 11 mg/mL, about 13 mg/mL, or about 15 mg/mL. In further embodiments, the bulk MoS₂ material is present in the NMP in an amount of about 5 mg/mL. The bulk MoS₂ material has a two-dimensional layered structure, with each individual layer stacked upon each other to form the bulk single crystal. Each layer of the bulk MoS₂ material may contain a plane of hexagonally arranged molybdenum atoms, positioned between two planes of hexagonally arranged sulfur atoms. In some embodiments, each layer is bound by weak van der Waals forces. Therefore, MoS₂ nanosheets can be obtained from the bulk MoS₂ material via mechanical exfoliation, such as sonication.

In some embodiments, the sonicating is carried out in a bath sonicator set to a frequency of about 10 to about 100 kilohertz (kHz), such as about 15 to about 90 kHz, about 20 to about 80 kHz, about 25 to about 70 kHz, about 30 to about 60 kHz, about 35 to about 50 kHz, or about 40 kHz, and at an amplitude of about 10 to about 100%, such as about 15 to about 90%, about 20 to about 80%, about 25 to about 70%, about 30 to about 60%, about 35 to about 50%, or about 40% based on a maximum displacement from the equilibrium position. In some embodiments, the sonicating is carried out for about 1 to about 24 hours, such as about 2 to about 16 hours, about 4 to about 12 hours, or about 8 hours.

The exfoliation method further includes separating the MoS₂ in the form of nanosheets from the suspension by centrifugation. The centrifugation of the suspension is performed at about 1000 to about 9000 rpm, such as about 2000 to about 8000 rpm, about 3000 to 7000 rpm, about 4000 to about 6000 rpm, or about 4500 rpm for about 10 to about 120 minutes, such as about 15 to about 60 minutes, about 20 to about 30 minutes, or about 20 minutes.

The MoS₂ catalyst in the form of a flower-like nanosheet microsphere and prepared using the hydrothermal process in the presence of a reducing agent, may be used for diverse applications including but not limited to H₂S splitting. This hydrothermal method may improve the efficiency and stability of the catalysts. By incorporating the reducing agent like oxalic acid, the structure and properties of the MoS₂ catalyst is improved under mild conditions. The increased surface area and active sites on the flower-like nanosheet microsphere can enhance the yield and production rate of hydrogen produced in the H₂S splitting process, while reducing operational temperatures and energy consumption.

### EXAMPLES

The following examples demonstrate methods for converting hydrogen sulfide to hydrogen and sulfur using metal sulfide catalysts, such as a molybdenum disulfide (MoS₂) catalyst, as described herein. The examples are provided solely for illustration and are not to be construed as limitations of the present disclosure, as many variations thereof are possible without departing from the spirit and scope of the present disclosure.

### Materials

Sodium molybdate dehydrate (Na₂MoO₄·2H₂O, also referred to herein as “S”) and ammonium heptamolybdate ((NH4)₆Mo₇O₂₄, also referred to herein as “A”) were used as a molybdate salt. Thioacetamide (CH₃CSNH₂, also referred to herein as “TA”) and thiourea (CH₄N₂S, also referred to herein as “T”) were used as a sulfide precursor. Citric acid monohydrate (C₆H₈O₇·H₂O, also referred to herein as “C”), oxalic acid (C₂H₂O₄, also referred to herein as “O”), and ascorbic acid (C₆H₈O₆, also referred to herein as “L”) were used as a reducing agent (also referred to herein as “chemical reducing agent,” or “chemical reducing reagent,” or “reducing reagent”).

### Example 1: Hydrothermal Synthesis of a MoS₂ Catalyst

A calculated amount of a molybdate salt was dissolved into about 30 mL of deionized water at room temperature, followed by the addition of an appropriate amount of a reducing agent (e.g., from about 0.05 g to about 0.378 g) to form a first mixture. The first mixture was mixed under vigorous magnetic stirring for about 20 minutes. In the meantime, a calculated amount of a sulfide precursor was dissolved into another about 30 mL of deionized water at room temperature under vigorous magnetic stirring for about 20 minutes, to form a second mixture. Then, the first mixture containing the molybdenum salt was added slowly to the second mixture containing the sulfur precursor. Finally, the resulting mixture was transferred into a 100 mL Teflon-lined stainless-steel autoclave and heated at about 160 to about 220° C. for about 24 hours. After the autoclave was cooled to room temperature, the resulting black product was washed several times with distilled water and absolute ethanol, respectively. The products were dried at about 80° C. for about 10 hours. Table 1 shows the MoS₂ catalysts obtained using different synthetic conditions. As discussed herein, by varying the synthetic conditions, catalysts can be prepared with various surface morphologies.

TABLE 1
Synthetic conditions of different MoS₂ catalyst
samples using the hydrothermal method.

| Sample | Molybdenum source | Sulfur source | Reducing agent |
|---|---|---|---|
| Cat-1 | Na₂MoO₄•2H₂O, 5 mmol | CH₄N₂S | None |
| Cat-2 | (NH₄)₆Mo₇O₂₄, 0.8 mmol | CH₄N₂S | None |
| Cat-3 | (NH₄)₆Mo₇O₂₄, 0.8 mmol | CH₃CSNH₂ | None |
| Cat-4 | Na₂MoO₄•2H₂O, 5 mmol | CH₃CSNH₂ | None |
| Cat-5 | Na₂MoO₄•2H₂O, 5 mmol | CH₄N₂S | oxalic acid |
| | | (Thiourea) | |
| Cat-6 | Na₂MoO₄•2H₂O, 5 mmol | CH₄N₂S | L-ascorbic acid |
| Cat-7 | Na₂MoO₄•2H₂O, 5 mmol | CH₄N₂S | citric acid |
| | | | monohydrate |
| Cat-8 | (NH₄)₆Mo₇O₂₄, 0.8 mmol | CH₄N₂S | L-ascorbic acid |
| Cat-9 | (NH₄)₆Mo₇O₂₄, 0.8 mmol | CH₄N₂S | citric acid |
| | | | monohydrate |
| Cat-10 | (NH₄)₆Mo₇O₂₄, 0.8 mmol | CH₄N₂S | oxalic acid |
| Cat-11 | Na₂MoO₄•2H₂O, 5 mmol | CH₃CSNH₂ | L-ascorbic acid |
| Cat-12 | Na₂MoO₄•2H₂O, 5 mmol | CH₃CSNH₂ | citric acid |
| | | | monohydrate |
| Cat-13 | (NH₄)₆Mo₇O₂₄, 0.8 mmol | CH₃CSNH₂ | oxalic acid |
| Cat-14 | Na₂MoO₄•2H₂O, 5 mmol | CH₃CSNH₂ | oxalic acid |
| Cat-15 | (NH₄)₆Mo₇O₂₄, 0.8 mmol | CH₃CSNH₂ | L-ascorbic acid |
| Cat-16 | (NH₄)₆Mo₇O₂₄, 0.8 mmol | CH₃CSNH₂ | citric acid |
| | | | monohydrate |
| Cat-17 | (NH₄)₆Mo₇O₂₄, 0.8 mmol | CH₄N₂S | None |
| Cat-18 | (NH₄)₆Mo₇O₂₄, 0.8 mmol | CH₄N₂S | oxalic acid |
| Cat-19 | (NH₄)₆Mo₇O₂₄, 0.8 mmol | CH₄N₂S | oxalic acid |
| Cat-20 | (NH₄)₆Mo₇O₂₄, 0.8 mmol | CH₄N₂S | oxalic acid |
| Cat-21 | (NH₄)₆Mo₇O₂₄, 0.8 mmol | CH₄N₂S | oxalic acid |
| Cat-22 | (NH₄)₆Mo₇O₂₄, 0.8 mmol | CH₄N₂S | oxalic acid |
| Cat-23 | (NH₄)₆Mo₇O₂₄, 0.8 mmol | CH₄N₂S | oxalic acid |
| Cat-24 | (NH₄)₆Mo₇O₂₄, 0.8 mmol | CH₄N₂S | oxalic acid |
| Cat-25 | (NH₄)₆Mo₇O₂₄, 0.8 mmol | CH₄N₂S | oxalic acid |
| Cat-26 | (NH₄)₆Mo₇O₂₄, 0.8 mmol | CH₄N₂S | oxalic acid |
| Cat-27 | (NH₄)₆Mo₇O₂₄, 0.8 mmol | CH₄N₂S | oxalic acid |
| Cat-28 | (NH₄)₆Mo₇O₂₄, 0.8 mmol | CH₄N₂S | oxalic acid |
| Cat-29 | (NH₄)₆Mo₇O₂₄, 0.8 mmol | CH₄N₂S | oxalic acid |
| Cat-30 | (NH₄)₆Mo₇O₂₄, 0.8 mmol | CH₄N₂S | oxalic acid |

### Example 2: Hydrothermal Synthesis of Other Metal Sulfide Catalysts

In addition to the MoS₂ catalysts, other types of metal sulfide catalysts including, but not limited to, HfS₂, NbS₂, PtS₂, TaS₂, TiS₂, VS₂, and ZrS₂, as well as doped MoS₂ catalysts were prepared according to the method described in Example 2 and the present disclosure. The molybdate salt was replaced with a calculated amount of a hafnium salt, a niobium salt, a platinum salt, a tantalum salt, a titanium salt, a vanadium salt, or a zirconium salt in whole or in part to generate corresponding metal sulfide catalysts.

### Example 3: Exfoliation Synthesis of a MoS₂ Catalyst

A MoS₂ catalyst in the form of exfoliated MoS₂ nanosheet was also prepared using an exfoliation method. The exfoliated MoS₂ nanosheet is produced in a bath sonicator set to about 40 KHz frequency and about 40% amplitude. About 50 mg of MoS₂ bulk crystal was dispersed in about 10 mL of N-methyl 2-pyrrolidone (NMP), and the resulting solution was sonicated for about 8 hours at a constant temperature from 0 to about 50° C. to afford a MoS₂ suspension, as depicted in Table 2. The MoS₂ suspension has an olive-green color containing both exfoliated MoS₂ nanosheets and un-exfoliated sediments. The MoS₂ suspension was centrifuged at about 4500 rpm for about 20 minutes to separate the MoS₂ catalyst in the form of nanosheets and then the supernatant was collected using a micro-pipette for analysis. Table 2 shows the conditions used to produce the MoS₂ catalysts by the exfoliation method.

TABLE 2
Synthetic conditions of different MoS₂ catalyst
samples using the exfoliation method.

| Sample | Temperature (° C.) |
|---|---|
| Cat -31 | 0 |
| Cat-32 | 20 |
| Cat-33 | 35 |
| Cat-34 | 50 |

### Example 4: Catalyst Characterization

The crystal structure of the synthesized MoS₂ catalysts using the hydrothermal method was examined by X-ray diffractometer (XRD). The diffraction pattern was recorded over a 20 range from about 5° to about 90° at a step size of about 0.02°. The porous texture of the synthesized MoS₂ catalysts was analyzed by N₂ physisorption. The morphology of the synthesized MoS₂ catalysts was examined by Scanning Electron Microscopy (SEM) and Transmission Electron Microscope (TEM).

### Example 5: XRD Results

The XRD patterns of selected hydrothermally synthesized catalysts are depicted in FIGS. 1A to 1D. FIG. 1A illustrates catalysts synthesized based on various sulfide and molybdate precursors in the absence of a chemical reducing agent. For thiourea-based catalysts (samples Cat₁ and Cat₂) with both molybdate sources, diffraction peaks at 2θ=14°, 32°, 39°, and 58° are observed. These peaks correspond to the (002), (100), (103), and (110) lattice planes of the MoS₂ hexagonal structure (JCPDS card No. 37-1492). In contrast, samples Cat₃ and Cat₄ display partial profile peaks of MoS₂ at 2θ=32° and 39° with other impurity peaks, indicating that thiourea can be used as a sulfide source.

FIG. 1B illustrates catalysts synthesized based on chemical reducing agents added to sodium molybdate/thiourea-based catalysts during synthesis. The diffraction peaks (002), (103), and (110) are stronger and sharper for the oxalic acid-based catalyst (sample Cat₅), showing improved crystalline nanosheets due to the addition of oxalic acid. In contrast, adding citric acid monohydrate and L-ascorbic acid (samples Cat₆ and Cat₇) results in absent diffraction peaks at 2θ=14°, 32° with a weaker XRD profile than that of sample Cat₁.

FIG. 1C illustrates catalysts prepared by incorporating a chemical reducing agent to ammonium heptamolybdate/thiourea-based catalysts during the synthesis. Samples Cat₈ to Cat₁₀ exhibit typical MoS₂ peaks, which are relatively sharp, indicating a high degree of crystallinity and well-structured development. The oxalic acid-based catalyst (sample Cat₁₀) shows the highest diffraction peaks on the (002) and (103) lattice planes, indicating that the sheets are grown along the (002) and (103) lattice planes.

FIG. 1D illustrates the synthesized catalysts (samples Cat₁₁ to Cat₁₆), which lacks certain XRD peaks of MoS₂. This may be attributed to the amorphous structure of the catalysts produced under the synthesis conditions.

### Example 6: N₂ Adsorption/Desorption Isotherms

FIGS. 2A and 2B illustrate the N₂ sorption isotherm and the pore diameter for selected MoS₂ catalysts in comparison to a commercial MoS₂ catalyst (also referred to herein as “CM”). FIG. 2A shows that samples Cat₅ to Cat₁₀ exhibit improved mesopore surface area compared to the CM. Sample Cat₁₀ has a surface area of about 32 m²/g, which is about 12 times greater than CM, followed by samples Cat₆ and Cat₈.

### Example 7: Morphology Examination

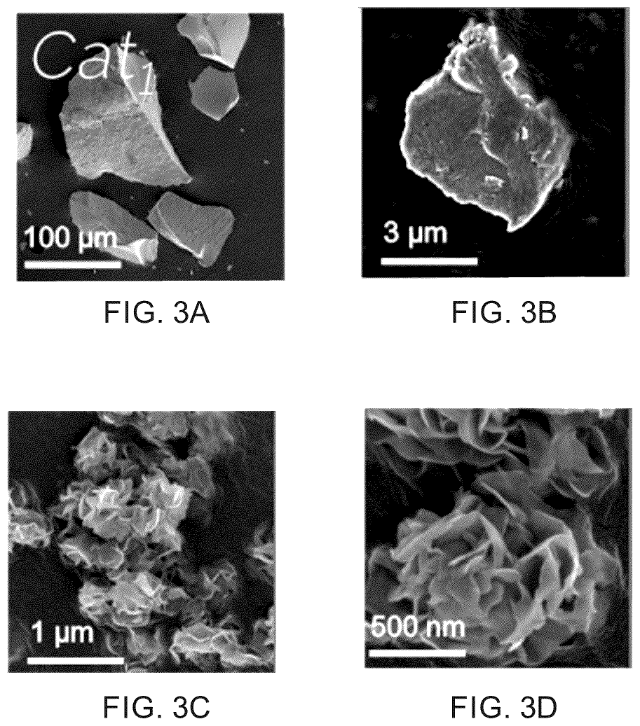

FIGS. 3A-3D, 4A-4D, 5A-5D, 6A-6D, 7A-7D, 8A-8D, 9A-9D, and 10A-10D show the morphologies of selected MoS₂ catalysts. Samples Cat₁ and Cat₂, synthesized in the absence of a chemical reducing agent, exhibit chunky, rough-surfaced structures with a particle size ranging between about 10 and about 50 μm. The MoS₂ catalysts synthesized in the presence of a chemical reducing agent display unique morphologies resembling flower-like, hollow microspheres. These observations indicate that the chemical reducing agent can impact the morphology and size of the flower-like MoS₂ nanosheet microsphere. Samples Cat₅ to Cat₇ illustrate micron sheets with wrinkled surfaces. Of all the catalysts prepared in the presence of a chemical reducing agent, catalysts prepared in the presence of oxalic acid show improved petite particle sizes and evenly distributed flower structure. This observation indicates that oxalic acid can regulate the diameter of the flower-like MoS₂ nanosheet microsphere.

### Example 8: H₂S Splitting

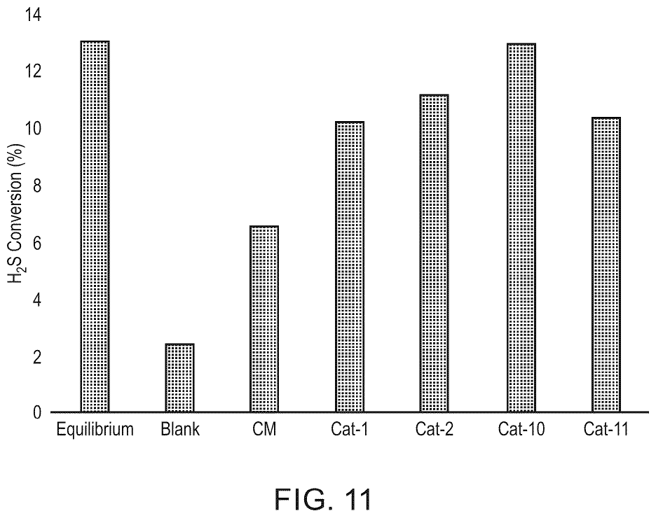

FIG. 11 illustrates the H₂S splitting performance of selected MoS₂ catalysts prepared by the hydrothermal method of the present disclosure in comparison with the commercial MoS₂ catalyst. As can be seen, Sample Cat₁₀ shows enhanced conversion (which reaches equilibrium conversion), nearly double the conversion of the commercial MoS₂ catalyst. H₂S conversion of a catalysts prepared by the hydrothermal method of the present disclosure was conducted using a spacetime of 0.03 g s mL⁻¹, at about 700° C. and a feed of about 2% (vol) H₂S in N₂. Blank data refers to running the reaction in an empty reactor.

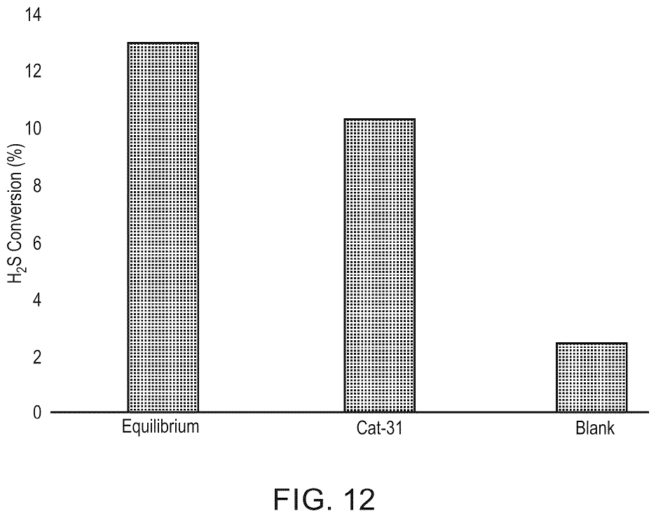

FIG. 12 illustrates the H₂S splitting performance of selected MoS₂ catalysts prepared by the exfoliation method of the present disclosure in comparison with the commercial MoS₂ catalyst. As depicted in FIG. 12, Cat₃₁ is substantially close to the thermodynamic equilibrium. In some embodiments, H₂S conversion of a catalysts prepared by the exfoliation method of the present disclosure was conducted using a spacetime of 0.03 g s mL⁻¹, at about 700° C. and a feed of about 2% (vol) H₂S in N₂. Blank data refers to running the reaction in an empty reactor.

### Example 9: DFT Calculations

Density functional theory (DFT) calculation was performed to examine variants that may impact the catalytic activity of various metal sulfide catalysts towards H₂S splitting. The H₂S binding energy (ΔE_{H2S}) and S₂ binding energy (ΔE_{S2}) were obtained from the computational calculations (Hassan Aljama, Zainab Alaithan, and Ali Almofleh, J. Phys. Chem. C 2023, 127, 19, 9022-9029, which is incorporated herein by reference in its entirety).

A strong H₂S binding energy (ΔE_{H2S}) (more negative (ΔE_{H2S}) indicates higher activity of the catalyst towards dissociating H₂S. A weak S₂ binding energy (less negative ΔE_{S2}) allows for a better sulfur desorption ability from the catalyst surface. Therefore, catalysts that display both a stronger H₂S binding energy (about <−0.2 eV) and a weaker S₂ binding energy (about >−3 eV) are applicable in H₂S dissociation.

Additionally, several catalysts were examined using different configurations of the active sites to allow for an accurate representation of the material. Table 3 shows the DFT calculated H₂S and S₂ binding energies for the selected catalysts. TiS₂, TaS₂ and VS₂ fit the energy criteria which has a strong H₂S binding energy and a weak S₂ binding energy.

TABLE 3
DFT calculated energies.

| Catalyst | E_{H2S} (eV) | E_{S2} (eV) |
|---|---|---|
| TaS₂ | −0.53 | −2.3 |
| VS₂ | −0.72 | −2.4 |
| NbS₂ | −0.4 | −1.5 |
| TiS₂ | −0.3 | −2.7 |

The flower-like nanosheet microsphere MoS₂ catalyst synthesized by the hydrothermal method of the present disclosure in the presence of a reducing agent, such as oxalic acid, finds applications in various fields including, but not limited to H₂S splitting and hydrotreatment. This hydrothermal method can enhance the efficiency and stability of the MoS₂ catalyst. The employment of oxalic acid as a reducing agent in the preparation of the flower-like nanosheet microsphere under mild conditions shows improvement in catalyst structure and properties. The increased surface area and active sites on the flower-like nanosheet microsphere can thus enhance hydrogen yield and production rate. Moreover, the H₂S splitting using the MoS₂ catalyst operates effectively at low temperatures, leading to reduced energy demands and costs for industrial applications.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

### Embodiments

1. A method for converting hydrogen sulfide (H₂S) to hydrogen (H₂) and sulfur(S), the method comprising:
introducing a H₂S-containing feed gas stream into a reactor comprising a molybdenum disulfide (MoS₂) catalyst, wherein the MoS₂ catalyst is in the form of a flower-like nanosheet microsphere or a nanosheet;
passing the H₂S-containing feed gas stream through the reactor to contact the H₂S-containing feed gas stream with the MoS₂ catalyst at a temperature of about 500 to about 1000° C., thereby converting at least a portion of the H₂S to H₂ and S and producing a spent catalyst in-situ and a residue gas stream leaving the reactor, wherein the S is deposited on surfaces and pores of the MoS₂ catalyst in the formation of the spent catalyst; and
separating the H₂ from the residue gas stream to generate a H₂-containing product gas stream.

2. The method of embodiment 1, wherein the H₂S is present in the H₂S-containing feed gas stream at a concentration of about 0.5 to about 90 volume percentage (vol. %) based on a total volume of the H₂S-containing feed gas stream.

3. The method of embodiments 1 or 2, wherein the H₂S-containing feed gas stream further comprises an inert gas selected from the group consisting of nitrogen, argon, and helium.

4. The method of any one of embodiments 1-3, wherein the reactor is selected from the group consisting of a fixed-bed reactor, a trickle-bed reactor, a moving bed reactor, a rotating bed reactor, a fluidized bed reactor, and a slurry reactor.

5 The method of any one of embodiments 1-4, wherein the passing the H₂S-containing feed gas stream through the reactor is carried out at a spacetime of about 0.01 to about 10 grams seconds per milliliter (g s mL⁻¹) at a temperature of about 700° C. 6. The method of any one of embodiments 1-5, wherein the conversion of H₂S to H₂ and S is about 7 to about 20% based on an initial concentration of the H₂S in the H₂S-containing feed gas stream at a temperature of about 700° C. 7. The method of any one of embodiments 1-6, wherein the MoS₂ catalyst is in the form of a flower-like nanosheet microsphere.

8. The method of any one of embodiments 1-7, wherein the flower-like nanosheet microsphere has an average particle size of about 400 to about 1000 nanometers (nm).

9. The method of any one of embodiments 1-8, wherein each flower-like nanosheet microsphere comprises a hollow spherical core and a plurality of interconnected nanosheets growing perpendicular to a surface of the hollow spherical core.

10. The method of any one of embodiments 1-9, wherein the plurality of interconnected nanosheets have an average width of about 100 to about 300 nm and an average thickness of about 1 to about 15 nm.

11. The method of any one of embodiments 1-10, wherein the flower-like nanosheet microsphere has a surface area in a range of about 20 to about 50 square meters per gram (m²/g).

12. The method of any one of embodiments 1-11, wherein the MoS₂ catalyst is supported on a support material, and wherein the support material is selected from the group consisting of a metal oxide, a carbon material, a silica material, and combinations thereof.

13. The method of any one of embodiments 1-12, wherein the support material is alumina.

14. The method of any one of embodiments 1-13, further comprising regenerating the MoS₂ catalyst by washing the spent catalyst with two or more solvents and drying.

15. The method of any one of embodiments 1-14, further comprising preparing the MoS₂ catalyst by a hydrothermal method, wherein the hydrothermal method comprises:
mixing a molybdenum salt and a reducing agent in water to form a first mixture;
mixing a sulfur precursor in water to form a second mixture;
mixing the first mixture with the second mixture to form a reaction mixture;
heating the reaction mixture at a temperature of about 160 to about 220° C. to form a crude product in the form of a precipitate; and separating the crude product from the reaction mixture and drying.

16. The method of any one of embodiments 1-15, wherein the molybdenum salt is selected from the group consisting of sodium molybdate (Na₂MoO₄), potassium molybdate (K₂MoO₄), calcium molybdate (CaMoO₄), barium molybdate (BaMoO₄), lithium molybdate (Li₂MoO₄), magnesium molybdate (MgMoO₄), zinc molybdate (ZnMoO₄), ammonium heptamolybdate ((NH4)₆Mo₇O₂₄), ammonium orthomolybdate ((NH4)₂MoO₄), hydrates thereof, and mixtures thereof.

17. The method of any one of embodiments 1-16, wherein the reducing agent is selected from the group consisting of citric acid, oxalic acid, ascorbic acid, hydrates thereof, and mixtures thereof.

18. The method of any one of embodiments 1-17, wherein the sulfur precursor is selected from the group consisting of thioacetamide (CH₃CSNH₂) and thiourea (CH₄N₂S), hydrates thereof, and mixtures thereof.

19. The method of any one of embodiments 1-18, further comprising preparing the MoS₂ catalyst by an exfoliation method, wherein the exfoliation method comprises:
dispersing a bulk MoS₂ material in a solvent to form a suspension and sonicating at a temperature of about 0 to about 50° C.; and
separating the MoS₂ in the form of nanosheets from the suspension by centrifugation.

20. The method of any one of embodiments 1-19, wherein the solvent is selected from the group consisting of an aromatic solvent, a ketone solvent, a glycol solvent, an ester solvent, an amine solvent, an amide solvent, an alcohol solvent, a polar protic solvent, a polar aprotic solvent, water, and mixtures thereof.

1. A method for converting hydrogen sulfide (H₂S) to hydrogen (H₂) and sulfur(S), the method comprising:
introducing a H₂S-containing feed gas stream into a reactor comprising a molybdenum disulfide (MoS₂) catalyst, wherein the MoS₂ catalyst is in the form of a flower-like nanosheet microsphere or a nanosheet;
passing the H₂S-containing feed gas stream through the reactor to contact the H₂S-containing feed gas stream with the MoS₂ catalyst at a temperature of about 500 to about 1000° C., thereby converting at least a portion of the H₂S to H₂ and S and producing a spent catalyst in-situ and a residue gas stream leaving the reactor, wherein the S is deposited on surfaces and pores of the MoS₂ catalyst in the formation of the spent catalyst; and
separating the H₂ from the residue gas stream to generate a H₂-containing product gas stream.

2. The method of claim 1, wherein the H₂S is present in the H₂S-containing feed gas stream at a concentration of about 0.5 to about 90 volume percentage (vol. %) based on a total volume of the H₂S-containing feed gas stream.

3. The method of claim 1, wherein the H₂S-containing feed gas stream further comprises an inert gas selected from the group consisting of nitrogen, argon, and helium.

4. The method of claim 1, wherein the reactor is selected from the group consisting of a fixed-bed reactor, a trickle-bed reactor, a moving bed reactor, a rotating bed reactor, a fluidized bed reactor, and a slurry reactor.

5. The method of claim 1, wherein the passing the H₂S-containing feed gas stream through the reactor is carried out at a spacetime of about 0.01 to about 10 grams seconds per milliliter (g s mL⁻¹) at a temperature of about 700° C.

6. The method of claim 1, wherein the conversion of H₂S to H₂ and S is about 7 to about 20% based on an initial concentration of the H₂S in the H₂S-containing feed gas stream at a temperature of about 700° C.

7. The method of claim 1, wherein the MoS₂ catalyst is in the form of a flower-like nanosheet microsphere.

8. The method of claim 7, wherein the flower-like nanosheet microsphere has an average particle size of about 400 to about 1000 nanometers (nm).

9. The method of claim 7, wherein each flower-like nanosheet microsphere comprises a hollow spherical core and a plurality of interconnected nanosheets growing perpendicular to a surface of the hollow spherical core.

10. The method of claim 9, wherein the plurality of interconnected nanosheets have an average width of about 100 to about 300 nm and an average thickness of about 1 to about 15 nm.

11. The method of claim 7, wherein the flower-like nanosheet microsphere has a surface area in a range of about 20 to about 50 square meters per gram (m²/g).

12. The method of claim 1, wherein the MoS₂ catalyst is supported on a support material, and wherein the support material is selected from the group consisting of a metal oxide, a carbon material, a silica material, and combinations thereof.

13. The method of claim 12, wherein the support material is alumina.

14. The method of claim 1, further comprising regenerating the MoS₂ catalyst by washing the spent catalyst with two or more solvents and drying.

15. The method of claim 1, further comprising preparing the MoS₂ catalyst by a hydrothermal method, wherein the hydrothermal method comprises:
mixing a molybdenum salt and a reducing agent in water to form a first mixture;
mixing a sulfur precursor in water to form a second mixture;
mixing the first mixture with the second mixture to form a reaction mixture;
heating the reaction mixture at a temperature of about 160 to about 220° C. to form a crude product in the form of a precipitate; and
separating the crude product from the reaction mixture and drying.

16. The method of claim 15, wherein the molybdenum salt is selected from the group consisting of sodium molybdate (Na₂MoO₄), potassium molybdate (K₂MoO₄), calcium molybdate (CaMoO₄), barium molybdate (BaMoO₄), lithium molybdate (Li₂MoO₄), magnesium molybdate (MgMoO₄), zinc molybdate (ZnMoO₄), ammonium heptamolybdate ((NH4)₆ Mo₇O₂₄), ammonium orthomolybdate ((NH4)₂MoO₄), hydrates thereof, and mixtures thereof.

17. The method of claim 15, wherein the reducing agent is selected from the group consisting of citric acid, oxalic acid, ascorbic acid, hydrates thereof, and mixtures thereof.

18. The method of claim 15, wherein the sulfur precursor is selected from the group consisting of thioacetamide (CH₃CSNH₂) and thiourea (CH₄N₂S), hydrates thereof, and mixtures thereof.

19. The method of claim 1, further comprising preparing the MoS₂ catalyst by an exfoliation method, wherein the exfoliation method comprises:
dispersing a bulk MoS₂ material in a solvent to form a suspension and sonicating at a temperature of about 0 to about 50° C.; and
separating the MoS₂ in the form of nanosheets from the suspension by centrifugation.

20. The method of claim 19, wherein the solvent is selected from the group consisting of an aromatic solvent, a ketone solvent, a glycol solvent, an ester solvent, an amine solvent, an amide solvent, an alcohol solvent, a polar protic solvent, a polar aprotic solvent, water, and mixtures thereof.
